(19) United States
(12) Patent Application Publication
(10) Pub. No.: US 2017/0277775 A1
(43) Pub. Date: Sep. 28, 2017

(54) SYSTEMS AND METHODS FOR SECURE STORAGE OF USER INFORMATION IN A USER PROFILE

(71) Applicant: FHOOSH, INC., La Jolla, CA (US)

(72) Inventors: Linda EIGNER, La Jolla, CA (US); William EIGNER, La Jolla, CA (US); Eric TOBIAS, La Jolla, CA (US); Charles KAHLE, Escondido, CA (US); Anthony F. IASI, San Diego, CA (US)

(73) Assignee: FHOOSH, INC., La Jolla, CA (US)

(21) Appl. No.: 15/622,033

(22) Filed: Jun. 13, 2017

Related U.S. Application Data
(63) Continuation-in-part of application No. 15/605,860, filed on May 25, 2017.
Application No. 15/605,860 is a continuation of application No. 14/061,736, filed on Oct. 23, 2013, now Pat. No. 9,665,638.
(60) Provisional application No. 61/720,305, filed on Oct. 30, 2012.
(60) Provisional application No. 61/720,309, filed on Oct. 30, 2012.
(60) Provisional application No. 61/720,907, filed on Oct. 31, 2012.
(60) Provisional application No. 61/720,916, filed on Oct. 31, 2012.
(60) Provisional application No. 61/857,177, filed on Jul. 22, 2013.
(60) Provisional application No. 62/349,567, filed on Jun. 13, 2016.
(60) Provisional application No. 62/350,646, filed on Jun. 15, 2016.

(51) Int. Cl. G06F 17/30; G06F 17/24; G06F 21/60; G06F 3/0487; G06Q 30/02; H04L 29/08; H04W 4/08

(52) U.S. Cl. CPC G06F 17/30598; G06F 21/60; G06F 17/3071; G06Q 30/0204; G06F 17/30867; G06F 3/0487; H04W 4/08; G06F 17/30702; G06F 17/243; G06Q 30/0269; H04L 67/30

(57) ABSTRACT

A method for authenticated communications between devices, includes: establishing communications for data streaming between a first device and a second device; establishing a shared key; exchanging the shared key between the first device and the second device; encrypting a dataset by the first device using the shared key; decrypting the dataset by the second device using the shared key; evaluating key regeneration criteria to determine whether the shared key should be regenerated; in response to determining that the shared key should be regenerated, generating a new shared key, and encrypting a next dataset by the first device using the new shared key.

### CROSS-REFERENCE TO RELATED APPLICATIONS

This application is a continuation-in-part of U.S. application Ser. No. 15/605,860, filed on May 25, 2017, which is a continuation of U.S. application Ser. No. 14/061,736, filed on Oct. 23, 2013, now U.S. Pat. No. 9,665,638, which claims priority to U.S. Provisional Application Nos. 61/857,177, filed on Jul. 22, 2013, 61/720,907, filed on Oct. 31. 2012, 61/720,916, filed on Oct. 31, 2012, 61/720,309, filed on Oct. 30, 2012 and 61/720.305, filed on Oct. 30, 2012, the disclosures of all of which are incorporated herein in their entireties by reference. This application also claims the benefit of U.S. Provisional Application No. 62/349,567, filed Jun. 13, 2016, and U.S. Provisional Application No. 62/350,646, filed Jun. 15, 2016, the disclosures of all of which are incorporated herein in their entireties by reference.

### BACKGROUND

### 1. Field of the Invention

Various embodiments described herein. relate generally to the field of electronic management of information, and more particularly to secure storage and protection of user information in a user profile. Further, various embodiments described herein relate generally to the field of electronic data security and more particularly to the secure storage, management, and transmission of data, credentials and encryption keys at a client endpoint and during transmission.

### 2. Related Art

The vision of a paperless modem society is quickly becoming a reality, as more and more communications, services and transactions take place digitally across networks such as the Internet. The need for paper copies of correspondence, financial documents, receipts, contracts and other legal instruments is dwindling as electronic methods for securely transmitting, updating and accessing these documents increases. In addition to the electronic transmission and access to documents and correspondence, the process of electronically submitting information is also commonplace, such as with online shopping or applications for loans, credit cards, health insurance, college or job applications, etc.

However, much of the information required in these forms is common to other forms, and yet users manually repeat populating the form inputs with the same information over and over again. The ability to collect, organize, update, utilize and reapply the input information required in these electronic documents, forms and applications remains highly difficult. While some applications have been developed to store certain basic information about a user such as the user's name, address and financial information the ability to organize, access and, apply this stored information for additional online activities remains very limited, especially when detailed input information and/or computations are required to complete forms such as college applications and family law declarations.

There are several programs or applications that allow a user to track financial information, budget, forecast, balance spending accounts, etc. While these tools can save time and provide effective tools for budgeting etc., they do not address the numerous circumstances in which a user is required to provide personal information. financial information, forecasts, categorized expenditures, etc., in a specific format or in accordance with specific forms, etc.

For example, when someone gets divorced, they must provide the court with detailed personal and financial information, both of past records as well as projected needs. This information has to be provided in a very specific state-mandated format using a specific form and it must be updated and submitted to the court at various points during the divorce process, which may last over a long period of time. For example, FIG. 1 illustrates one page of an Income and Expense Declaration that both petitioner and respondent must fill out in a California divorce proceeding. The amount and complexity of the information needed for a form such as this typically requires the person completing the form such as the party to the divorce or an attorney to spend a significant amount of time obtaining all of the needed information and even performing calculations of information to obtain the desired values. As another example, when a user wishes to get a loan, such as a car loan or mortgage, the organization providing the loan will often require the user to provide and update certain financial records and information organized in a certain format.

Even well-organized, financially savvy users using currently available personal financial software tools find completing and updating these forms to be burdensome, time-consuming, confusing, and susceptible to mistake. The applicable forms and other applicable items require much more than basic financial information. Additionally, there is a significant need to accurately complete these forms, as the forms can obviously have a significant impact on whether the applicant qualifies for financial aid, a loan, etc., or receives a favorable outcome in a divorce or other legal proceeding.

These same challenges apply to other critical life events, such as applying to, and/or paying for college. The college application process is a high anxiety time for students and very often, their parents. There is a lot of detailed inform ion required to complete college and financial aid applications, including but not limited to essays, transcripts letters of recommendation, activities, photos, etc. Also, college applications and financial aid opportunities have many different deadlines. It is very difficult to stay organized and keep on top of all the information, deadlines and applications submitted.

Further, security of electronic data is of paramount importance for private individuals and for almost every conceivable business and government entity. A tremendous volume of electronic data is being generated, stored, and transmitted on a constant basis. Moreover, the breadth of electronic data, which nowadays inevitably extends to private and sensitive information, necessarily attracts a host of bad actors.

Conventional data security solutions are relatively static. For example, one or more data security mechanisms (e.g., password protection, encryption scheme) may be deployed at a particular data storage location. The same data security mechanisms swill generally remain in place until a significant security breach is detected, at which point the entire data storage location may have already been compromised.

Data that have been stored based on standard relational data models are particularly vulnerable to unauthorized access, Individual data records (e.g., name, address, social security number, credit card number, and bank account number) stored in separate storage locations are typically accompanied by a common record locator indicating logical nexus between the data records (e.g., associated with the same user). For example, individual data records may each be associated with the same user identification number. As such, unauthorized access to any one data record may expose sufficient information the user identification number) to gain access to the remainder of the data records.

Although numerous data security methods are available, implementing a flexible roster of seamlessly integrated and complementary data security solutions at a single data storage location remains an enormous challenge. For example, while combining security solutions will normally increase data security, incompatibilities between different solutions may in fact give rise to additional security risks.

Moreover, in order for a user to be able to store and retrieve data, there must be a way to identify that user and protect their data from being accessed by any other user. Traditionally, this is performed by “front-end” software where the user is authenticated and authorized through a login process.

The conventional login process is associated with a number of documented weaknesses, For example, in many systems, the login step is commonly considered a part of the user interface (UI) and a separate entity from the security bubble. The problem is magnified in cases where in-house developers, having limited background in security, attempt to build custom login authentication and authorization systems. As such, a malicious user can potentially have access to other users' data once that user is successfully completes the login process.

But these issues are also exacerbated by the fact that much of the data that is created today is created or accessed at a client endpoint, e.g., a computer, laptop, smartphone, tablet, Internet of things device etc. Even if the issues described above can be solved for data stored and retrieved at a server, there is the additional problem of securing the data at the endpoint. Thus. any solution to the above issues should take into account the fact that the client endpoint must also be secured.

### Key Exchange Methodologies

There are many forms of key exchange methodologies in current use for establishing a trusted communication link between two devices and to encrypt/decrypt transmitted data such as through symmetric shared secret keys or public/private asymmetric keys. Symmetric encryption uses the same key for both encrypting and decrypting data through any number of algorithms such as AES, Blowfish, DES, and Skipjack and is typically faster than asymmetric encryption. It is often used for bulk data encryption and when high rates of data throughput are necessary. In contrast, asymmetric encryption utilizes a pair of keys, public and private, where a public key is typically used to encrypt the data and the private key is used to decrypt the data. Asymmetric key algorithms can be 1000 times slower than symmetric key algorithms and therefore more corm only applied to key management or initial device authentication where there is not a continuous exchange of key pairs which would require enormous resource capability.

### Encrypted Data Transmission

In a common scenario here a large object needs to be sent encrypted to multiple client destinations and each client should have a uniquely encrypted copy, the traditional approach is to encrypt the original object using a different key for each client. If there are N clients and it takes an amount of time T to encrypt each object, the total encryption time is N×T.

### Data Encryption Speed

Currently, there are several approaches to increase performance (speed at which data can be encrypted). One approach is by using hardware-based acceleration. 128 bit and 256 bit AES ciphers can be accelerated 4 to 8 times through AES-NI hardware encryption (where available on Intel and AMD processors). It is also possible to decrease the key, size at the expense of security. AES with 256 bit keys is about 40% slower than AES with 128 bit keys. Another tactic is to use alternative encryption algorithms such as Blowfish which can produce a 20% speed improvement.

### Encryption Key Management

Encryption keys are typically used to encrypt, data or to encrypt other keys which are then used to encrypt data, the later commonly known as Key Encryption Keys (KEK). Managing keys and who has access to keys can be a daunting task. Key management software (KMS) attempts to make this job easier by providing user and administration access to all of the necessary keys. A KMS may also provide backup and redundancy services to safeguard a copy of the keys in case of a catastrophic server failure. User uptime is maintained when a replacement KMS is spun up quickly since access to encrypted data will not be possible unless the KMS is constantly up.

### Compound Security Keys

The concept of compound security keys is widely known and used in many scenarios. For example, a compound key for Alice and Bob to unlock a file affords them the ability to unlock the file but only if both of them unlock it in concert. Neither Bob or Alice independently unlock the file. These compound keys are typically static and must be re-written by an administrator when a change is required.

### Data Access Restriction

When access to data needs to be restricted, a commonly used approach is to configure access rights at the user level and/or establish groups of users each having different roles and permissions assigned to then. This ensures that user A, liar example, does not have access of User B's data. Another approach commonly used, for databases is to develop database query statements that check for any number of restrictions before allowing access to the data The problem with all these solutions is that they do not provide an easy way to have granular control t the data item level and these restrictions themselves are not universally encrypted.

### Hacking

Hackers spend an average of 200 days in a system before they are discovered. While inside, they observe traffic and make various attempts at locating additional credentials, usernames, passwords, etc. Access logs and behavioral analytics are some ways that detection efforts are focused on. In addition, “honey pot” files, databases, or servers are strategically placed in an attempt to slow down hackers.

### Ransomware

Ransomware is software surreptitiously installed on a computer that executes as encryption algorithm applied to all files visible to that computer, including those on network connected drives and cloud folders. The intent is to make the affected files unusable unless the victim pays a ransom amount at which point a decryption key is provided. There are products that attempt to identify early signs of an attack based on characteristics such as the appearance of files with extensions known to be generated by ransomware software or large number of file renaming activity. Another approach includes click-blocking software that prevents users from clicking on attachments in emails (the largest source of attacks). Finally, there are many malware solutions that monitor unusual running processes that could be a sign that there is an infection.

The most effective solution to protect against ransomware is to backup all files regularly ensuring that there are several, days' worth of backups. There are a variety of products that run backups on an automatic schedule. However, many backup systems use a mounted drive for the backup. If the ransomware virus can see, your files, it can see all of your drives including the one being used for backups. There are ways to protect the backup drive such as setting up proper access credentials and protocols. Being that ransomware is continually evolving and adapting, many of these solutions have been losing ground to the criminals.

### Searching Encrypted Data

There are a number of approaches for searching on encrypted data such as pre-indexing search fields or homomorphic encryption that allows evaluations and therefore searching on encrypted data. The greatest challenge is maintaining performance within acceptable limits and every method either slows the search process down or introduces a security weakness. In any case, these methods vary widely in implementation rarely following standards. These custom implementations make It difficult to leverage third party search tools.

### Data Encryption

Data is traditionally encrypted while in any number of states. For example, an entire hard-drive may be encrypted for data-at-rest. In another example, data-in-motion may be encrypted as it travels through a secure https connection. Data in databases may also be encrypted using methods where data in individual fields are encrypted in place while preserving the original table format. Other ad-hoc scenarios include encrypting single desktop folders or mounted disk drives.

In all these cases, the data to be encrypted is not organized into a format that is much different from their original footprint. The encrypted data merely replaces the original data in-place, or if replicated to other media, transferred to storage using a similar data and file hierarchy as the original data. Other techniques exist which do reorganize the data storage format, such as in the case with Data Sharding and Erasure Coding algorithms. These distribute the original data and that data may also be encrypted. However, the distribution and storage formats follow a rigid protocol imposed by the underlying algorithm thereby making it difficult to apply higher level capabilities and integration with existing legacy formats and/or third party solutions.

### SUMMARY

Disclosed herein are systems and methods fur securely storing information of a user in a user profile to prevent access to the information and minimize the amount of information disclosed during a security breach. Information pertaining to a user is obtained from one or more sources through electronic means, and the information is then classified into specific categories using field mapping and other techniques, after which it is organized into a user profile and securely stored in a database. The information that is collected and organized may include (but is not limited to) identification and contact information, financial information, health information, education and career information, family information business information, lifestyle information, and historical information for any of the listed categories. The user profile may be encrypted and stored remotely in a cloud-based system at a remote server, with portions of the profile stored in separate locations with separate encryption to minimize the risk of unauthorized access to one portion of the information. The fields of data in the user profile may also be separately encrypted with separate encryption keys and separately stored in separate data stores, databases, or in separate database tables, to minimize the amount of information which could be disclosed by the unauthorized access to a single encryption key or a single database, or database table.

In one aspect of the invention, a system for securely storing user information from a user profile comprises: a profile creation unit which creates a user profile of user information including a plurality of fields and a plurality of values for the plurality of fields; wherein the information in the user profile is separated into sections; and wherein the sections are separately stored in separate data stores, databases, or database tables.

In another aspect of the invention, a method of securely storing user information from a user profile comprises the steps of: creating a user profile of user information including a plurality of fields and a plurality of values for the plurality of fields; separating the information in the user profile into separate sections; and storing the separate sections in separate data stores, databases or database tables.

Also disclosed herein are systems and methods for secure storage, transmission and management of data, credentials and encryption keys are disclosed that include to and from the client endpoint are described. According to one aspect, a system for storing a first data object, comprising a plurality of storage locations; a secure platform comprising one or more processors; a client device comprising one or more processors, configured to: decompose the first data object into a first fragment associated with a first original record locator and a second fragment associated with a second original record locator; obfuscate the first original record locator to generate a first obfuscated record locator and the second original record locator to generate a second obfuscated record locator; encrypt the first fragment using a first encryption key and the second fragment using a second encryption key; and store, to at least a first of the plurality of storage locations, the first encrypted fragment with the corresponding first obfuscated record locator and the second encrypted fragment with the second obfuscated record locator.

Other features and advantages should become apparent from the following description of the preferred embodiments, taken in conjunction with the accompanying drawings.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding and shall neat be considered limiting of the breadth, scope, or applicability of the embodiments. It should be noted that for clarity and ease of illustration these drawings are not necessarily made to scale.

FIG. 1 is an image of an Income and Expense Declaration form used in a divorce proceeding.

FIG. 2 is a block diagram illustrating a system for obtaining, classifying and populating personal information on electronic forms, in accordance with various aspect in accordance with various aspects of the present disclosure;

FIG. 3 is a diagram further illustrating the system for obtaining, classifying and populating personal information do electronic forms, in accordance with various aspects of the present disclosure;

FIG. 4 is an illustration of the operations involved populating fields of a document in accordance with various aspects of this disclosure

FIG. 5 is a screen shot of a graphical user interface illustrating a browser extension implementing the inventive system, in accordance with various aspects of the present disclosure

FIG. 6 is an image of a database table listing field identifying numbers, field names and field values, in accordance with various aspects of the present disclosure;

FIG. 7 is an image of a database table of forms which are stored in the system for automatic completion, in accordance with various aspects of the present disclosure;

FIG. 8 is an image of a database table which lists field names and field values on each form document stored in the system, in accordance with various aspects of the present disclosure;

FIG. 9A is a screen shot of a graphical user interface illustrating a web interface for selecting a category of a document for pre-populating user information, in accordance with various aspects of the present disclosure;

FIG. 9B is a screen shot of a graphical user interface illustrating a web interface for selecting a specific document for pre-populating user information, in accordance with various aspects of the present disclosure;

FIG. 10A illustrates a graphical user interface of a form with a unique field name that can be automatically identified, stored in the system database, in accordance with various aspects of the present disclosure;

FIG. 10B illustrates a graphical user interface of the form of FIG. 10A with a value of the unique field stored in the system database populated into the field, in accordance with various aspects of the present disclosure;

FIG. 11 is an image of a database table which stores a field identifier, field name and field value for the unique field in the form illustrated in FIGS. 10A and 10B, in accordance with various aspects of the present disclosure;

FIG. 12 is a flow chart illustrating a method of obtaining, classifying and populating personal information onto an electronic form, in accordance with various aspects of the present disclosure;

FIG. 13 is a block diagram that illustrates an embodiment of a computer/server system upon which an embodiment in accordance with various aspects of the present disclosure may be implemented;

FIG. 14 is a reproduction of FIG. 1 of U.S. application Ser. No. 14/863,294, the disclosure of which application incorporated herein in its entirety by reference;

FIG. 15 is a reproduction of FIG. 1 of U.S. application Ser. No. 14/970,466, the disclosure of which application is incorporated herein in its entirety by reference;

FIG. 16 is a reproduction of FIG. 1 of U.S. Provisional Application No. 62/281,097, the disclosure of which application is incorporated herein in its entirety by reference;

FIG. 17 is a reproduction of FIG. 4 of U.S. Provisional Application No. 62/281,097;

FIG. 18 is a flowchart illustrating a method for exchanging keys in accordance with various aspects of the present disclosure;

FIG. 19 is a sequence diagram illustrating an encrypted data transmission sequence in accordance with various aspects of the present disclosure;

FIG. 20A is a flowchart illustrating a method for pre-slicing data to increase encryption speed in accordance with various aspects of the present disclosure;

FIG. 20B is a flowchart illustrating a method recombining a data file in accordance with various aspects of the present disclosure

FIG. 21 is a flowchart illustrating a method for managing encryption keys in accordance with various aspects of the present disclosure;

FIG. 22 is a flowchart illustrating a method for evaluating a compound key in accordance with various aspects of the present disclosure;

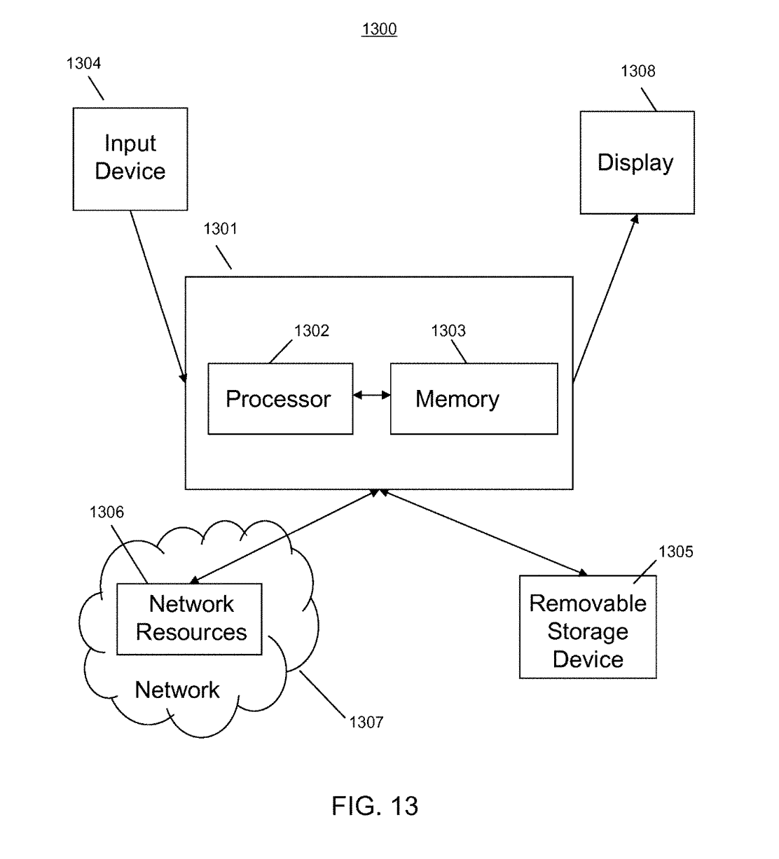

FIG. 13 is a flowchart illustrating a method for restricting data access in accordance with various aspects of the present disclosure;

FIG. 24 is a flowchart illustrating a method for detecting and responding to hacking attacks in accordance with various aspects of the present disclosure:

FIG. 25 is a flowchart illustrating a method for detecting and responding to ransomware attacks in accordance with various aspects of the present disclosure;

FIG. 26 is a flowchart illustrating a method for enabling searching on encrypted data in accordance with various aspects of the present disclosure; and

FIG. 27 is a flowchart illustrating a method for utilizing a virtual cryptological container for storing encrypted data in accordance with various aspects of the present disclosure.

The various embodiments mentioned above are described in further detail with reference to the aforementioned figured and the following detailed description of exemplary embodiments.

### DETAILED DESCRIPTION

The embodiments described herein provide or the collection, organization and use of information for automatically completing, updating and submitting complex electronic documents and online forms, such as: online shopping checkout forms; applications for loans, credit cards, health insurance, college or jobs; government-mandated documents required for legal proceedings (such as divorce or bankruptcy); and forms required for or by businesses and business owners. Information is obtained from a plurality of different sources and classified through field mapping and other information classification techniques to build an organized database of information related to a user known as an information vault. The information is securely stored via encryption and disassociation techniques in one or more user data stores or databases to ensure the security of the information. A forms database is utilized for storing electronic forms and documents as well as the field information needed to complete the form or document. The user can access their information to automatically populate the fields of an online form or an electronic document by selecting a document from the forms database or by utilizing a browser plug-in to populate an online form being displayed in a web browser. The system may also be integrated with third party services and websites to populate information on the third party site via secure connections to the user databases, while allowing the user to retain the information in our highly secure database.

The techniques described herein provide for the ability to quickly and accurately complete, update and submit any type of form on any type of computing device, as the user database builds a profile of the user that includes, for example, identification information, financial information, health information, contact information and historical user information that is classified with high accuracy to ensure that a form is populated with the correct information. The user retains full control of any downloading, transmission, editing or deleting of their information and only needs to enter and verify their information once rather than repeat the same process over and over again.

The systems and methods described herein may be utilized by individuals, groups, entities, governments or businesses for various types of information collection, management and entry. Individual users may populate online forms on their desktop, tablet, smartphone, etc., and be able to instantly complete the form. In one embodiment, the system may be offered as a mobile application running on a smartphone, tablet or other portable electronic device that would enable a user to complete forms or other documents. With the difficulty of inputting information using small display screens and touchscreen devices the ability to easily populate information with a portable electronic device is particularly advantageous. Businesses may organize and store information to complete forms such as human resource forms, building permit forms, elevator license forms in various jurisdictions, etc. Although the examples provided herein relate primarily to the use of the systems and methods for individual users, the benefits and applications also extend to groups of users, entities, governments or businesses of any size and type.

This solution is unique because once users enter their information once, the information is stored in their information vault, after which they can use it forever for supplying information or completing any forms that require the same repeat information. Non-limiting examples include new patient forms for health care, college admissions applications, scholarship applications, financial aid applications, loan applications, medical questionnaires, job applications, insurance forms, legal declaration or proceeding documents, government benefit or service requests, personal health records, ecommerce checkout forms, membership applications, etc.

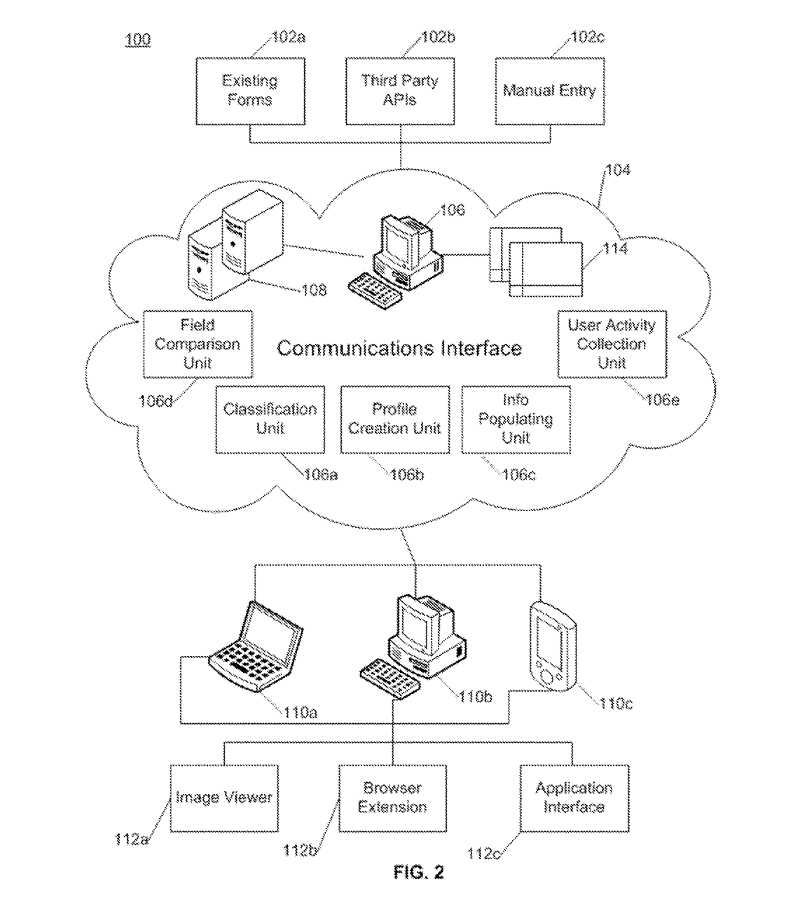

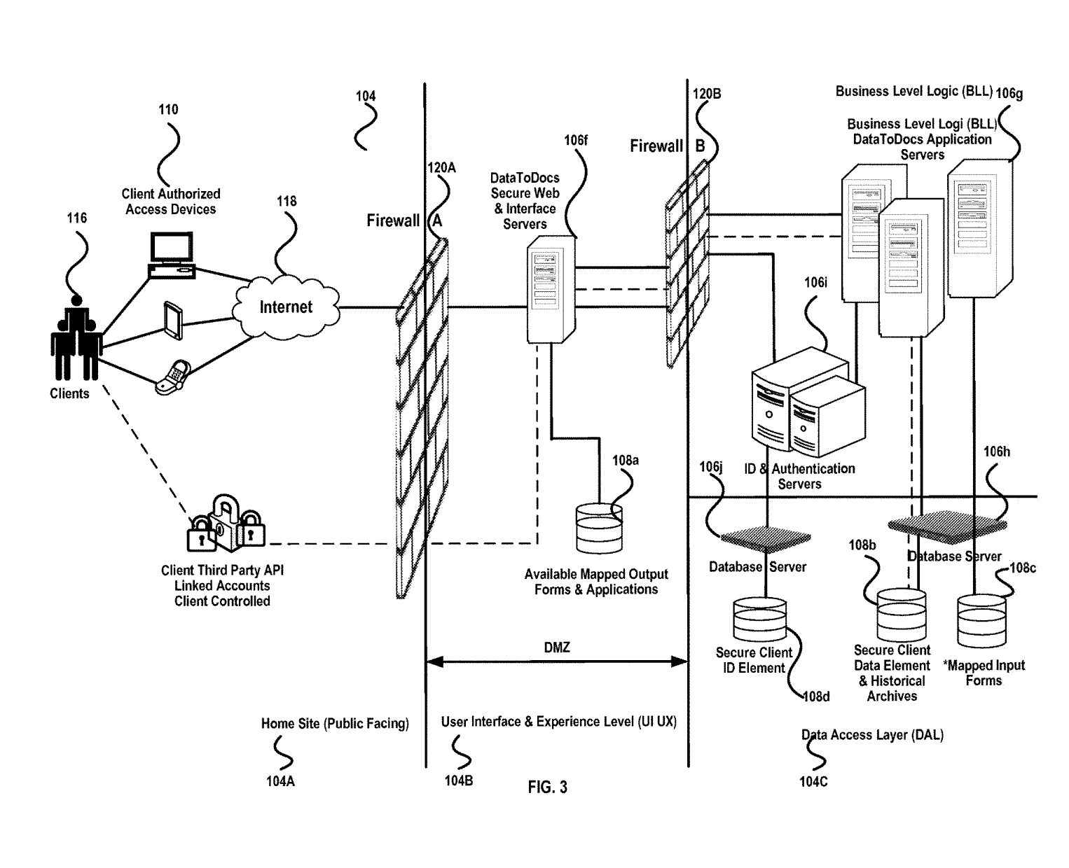

FIG. 2 illustrates one embodiment of a system 100 for obtaining, classifying and, populating information onto electronic forms, in accordance with one embodiment of the invention. Information is obtained from one or more information sources 102a-c, such as existing forms 102a, third party application interfaces 102b or manual user entry 102c. The information is then transmitted to a communications interface 104, where it is then classified by a server 106 and stored in one or more data storage devices, location, or systems data stores 108 as a user profile of the user's information. The communications interface 104 can be in a local area network (LAN) with the information sources 102 or at a remote location from the information sources 102 through connection via the Internet or other wide area network (WAN).

The communications interface 104 will also include one or more information processing units within the server 106 to process the collected information, including a classification unit 106a, which classifies the information to identify fields applicable to the information and values for the fields; a profile creation unit 106b, which creates a user profile with the classified information; and an information populating unit 106c, which populates at least one form field of an electronic form or database by matching the at least one form field with the classified information. A field comparison unit 106d and a user activity collection unit 106e 104 can also be included, the functions of which will be described further below. Any of the aforementioned units 104 can be located within separate servers or within a single server, depending on the design of the overall system. The user, through any type of device 110a-c, can then request that one or more forms 112 be completed using the information in their profile. Any type of device can be used by the user, including a laptop computer 110a, desktop computer 110b, or a portable electronic device 110c such as a tablet or smartphone.

The user can interact with the communications interface 104 through the device 110 to complete one or we forms 112a-c, such as an image viewer 112a, a form displayed in An internet-browser application 112b, or a form displayed via an application 112c running on the portable electronic device 110c. Forms can also be displayed directly in a browser window via HTML5-CSS3 or via an application 112c interfacing with the server 106, or through one or more graphical user interfaces (GUIs) 114 produced by the server 106 that are displayed on the device 110c. As demonstrated herein, the forms can be populated directly on the user's device, through a browser extension, add-on browser application, or via an application programming interface (API) interacting with a third party service or application.

FIG. 3 is an illustration of a system diagram illustrating the security protocol of one configuration of the system. Users 116 can access the system via the various devices 110 described above, which are connected with the communications interface 104 via the Internet 118. Multiple types, locations, devices, servers, etc. can be used separated between various firewalls for increased protection of the user profile information to ensure privacy and security. Users can initially be presented with a GUI showing basic information that is considered the public-facing home site 104a of the communication interface 104, which is also protected by an initial firewall 120a. The initial firewall 120a can provide overall security for the system and allow access to the user interface and experience level (UI/UX) 104b of the interface. The UI/UX 104b includes a web and interface server 106f connected with a forms and applications output data store 108a. A second firewall 120b can protect a third section of the communications interface known as the data access layer 104c. The data access layer 104c can include business level logic application servers 106g connected with a data store server 106h, which can be configured to manage a secure client data element and historical archives data store 108b and a mapped input forms data store 108c. Separate ID and authentication servers 106i can, also be enclosed within the data access layer 104c, which are connected with an identification data store server 106j, which can manage a secure client ID element data store 108d.

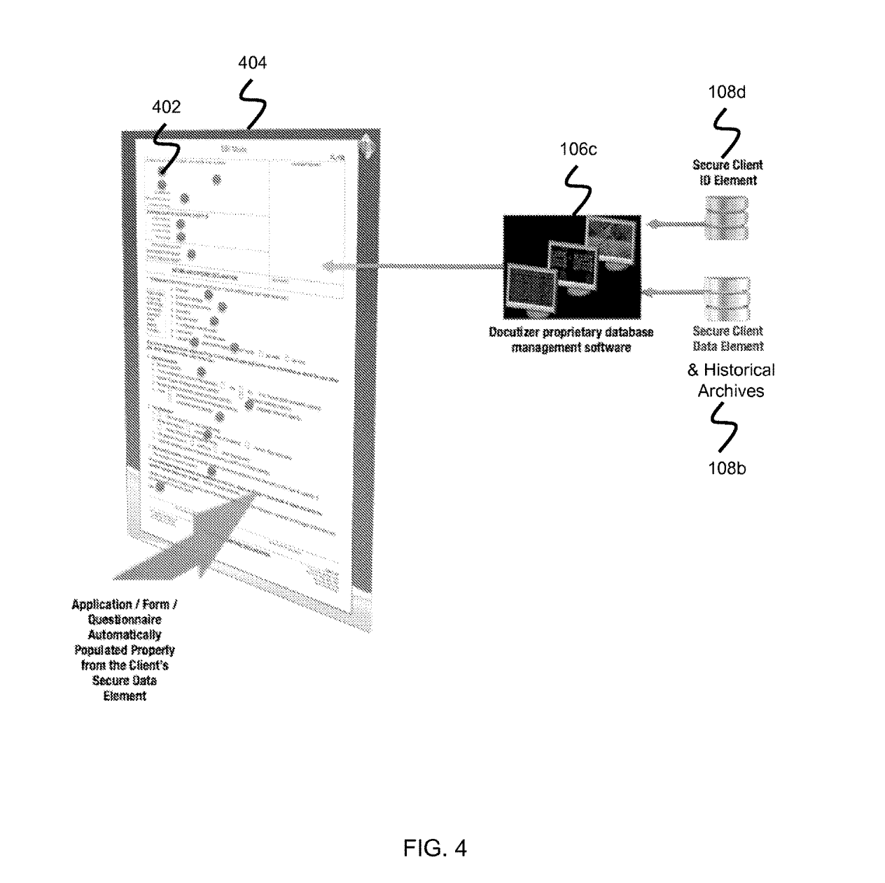

FIG. 4 illustrates one embodiment of the steps of populating fields 402 of a form 404 by accessing information stored in the secure client ID element data store 108d and the secure client data element data store 108b through data store management software such as the information populating unit 106c where a separate client identification data store and client information data store are used to obtain the information needed to populate an electronic form.

Details of the systems and methods are provided further herein with regard to the specific components and features.

### I. Collecting Information and Forms

Information can be obtained from multiple different sources and in multiple different formats in order to obtain a complete set of information for a user. For example, the user information can be obtained by having the user complete a “master form” specifically designed to collect information that many of the forms require in a variety of categories (i.e., loan applications, online shopping, college applications, divorce proceedings, etc.). The user information can also be collected from existing electronic or non-electronic records, such as financial institution databases, electronic health records, third party information aggregation services (such as Mint.com®), or by the user following simple instructions in the system's web-based user interface. The user may need to grant access to one or more of these existing electronic records so that the relevant information can be obtained, and the system can utilize specific Application Programming Interfaces (APIs) to communicate with the third party sites to obtain field and content information. For existing electro records, it is likely that the information is already classified within, database, with specific field names or identifications such that substantial additional classification of the information is not needed; however, due to the complexity of many of the forms such as divorce filings and financial schedules, the system is able to overlay additional computations and reorganize the classifications so that they match the required output of the forms. For non-electronic records, the user may be able to scan or take a picture of the non-electronic document and have the fields and field values extracted through various technologies such as image processing and content extraction software.

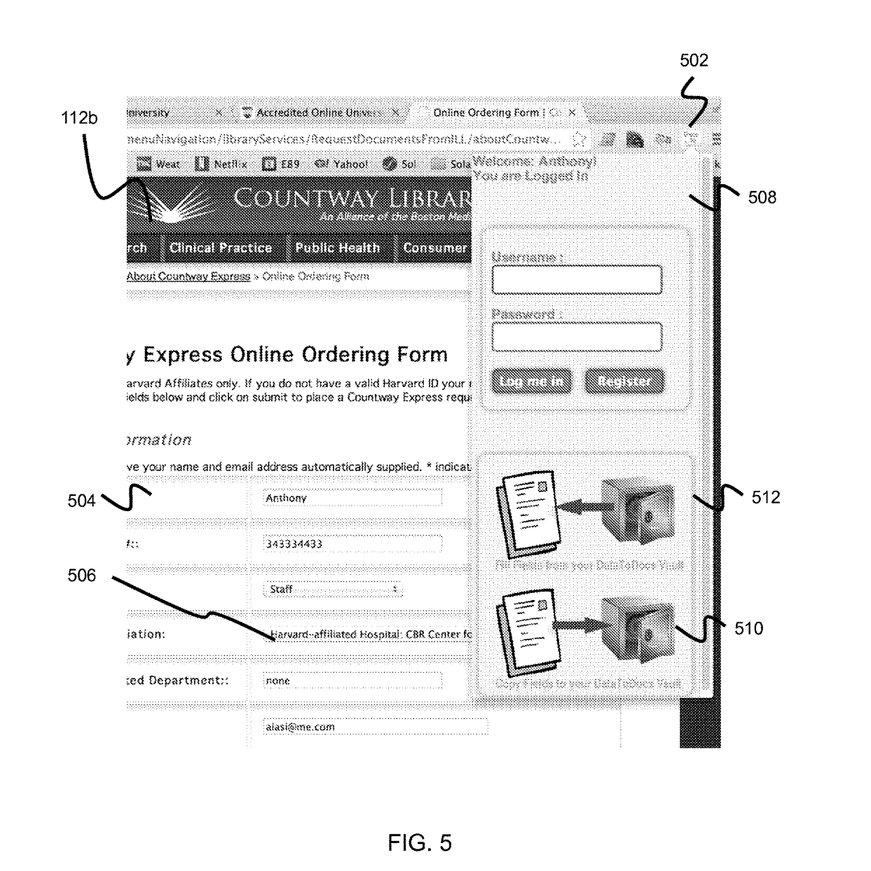

In one embodiment, the information can be obtained when a user manually completes an electronic form or document. For example, as illustrated in FIG. 5, if the user completes a form 112b displayed on an internet-browser application, the application can include a browser extension 502 to allow for the form 112b, fields 504 and content 506 of the fields to be captured, extracted, organized, classified and uploaded to the user's database for future use on the same or other forms. The browser extension 502 can provide a popup menu 508 with a Copy Button 510 to copy fields to the user profile, as well as a Fill Fields Button 512 to populate data from the user profile to the form 112b. The information can be extracted and populated even for a complete form that spans numerous pages. Blank forms and documents and other user information can also be directly uploaded to the system, where the form or document and its fields can be captured, mapped and stored as templates. For example, a credit card application form may be uploaded the system and stored in the document library data store, with the form fields identified so they can be mapped to the corresponding user fields in the data store, either manually or using automatic mapping techniques.

Completed forms and documents can also be directly uploaded to the system, where the form or document, the fields and content of the fields can be captured and extracted. For example, as credit card statement or a mortgage statement can be uploaded to the system, where the fields and content in the fields can be extracted and stored in the user data store, although the document itself cannot be since it is not a form. However, if a credit card application or a mortgage application is uploaded the document itself may be extracted and stored in addition to the fields and content to help the user and other users fill out the forms in the future.

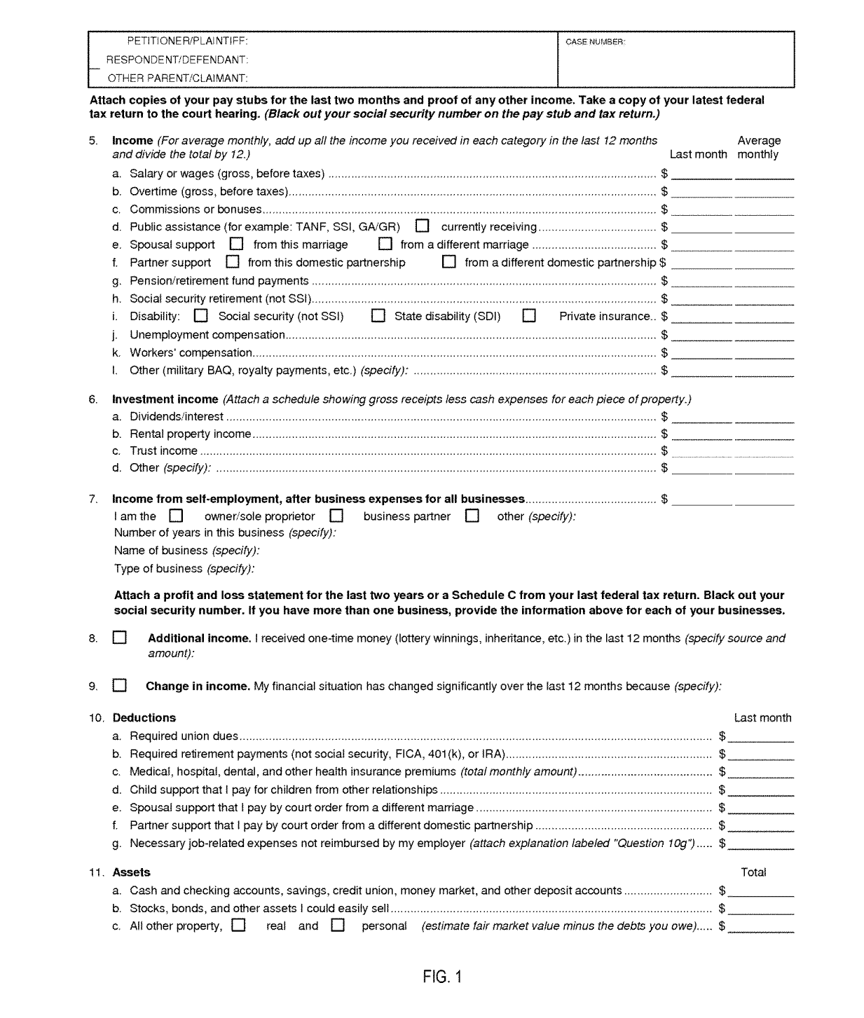

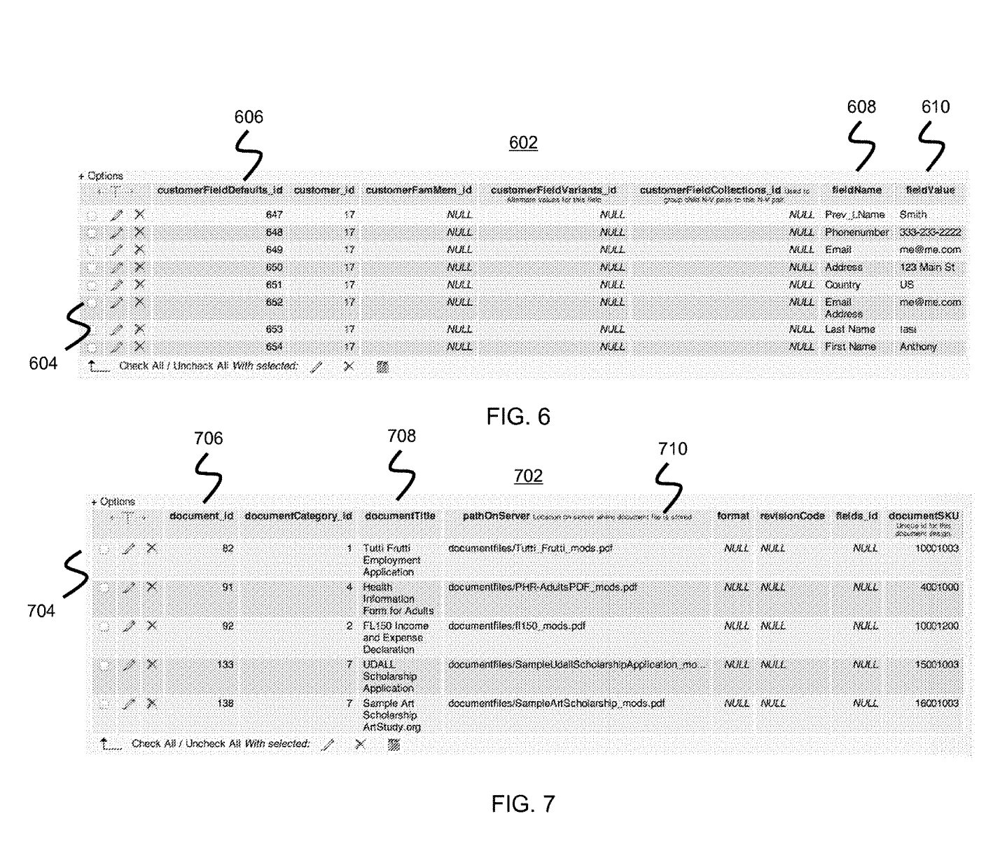

FIG. 6 illustrates one embodiment of a data store table 602 with the field information that is collected from a form that is input into the system. As information is sent from the form being worked on to the server, it gets stored in this table. When information is “pulled” from the server and applied to forms, it comes out of this table. The form can be a form such as that illustrated in FIG. 1 and can have been completed by the user such that the form fields have values already entered. As shown in FIG. 6, each field 604 on the form is provided a unique numerical identifier 606 (customerFieldDefaults_Id) to distinguish it from other fields. As shown in the right two columns, each field is also given a field name 608 (fieldName) and field value 610 (fieldValue). The field name may be the name encoded on the form itself which can be extracted from the form if it is on a website or an electronic form with field name metadata that has already identified the field name based on the programmer that created the original form. The field value (if available) will obviously correspond to the content of the field. The associations between field names and fieldvalues (known as name-value pairs) are important for classifying content and building the user profile.

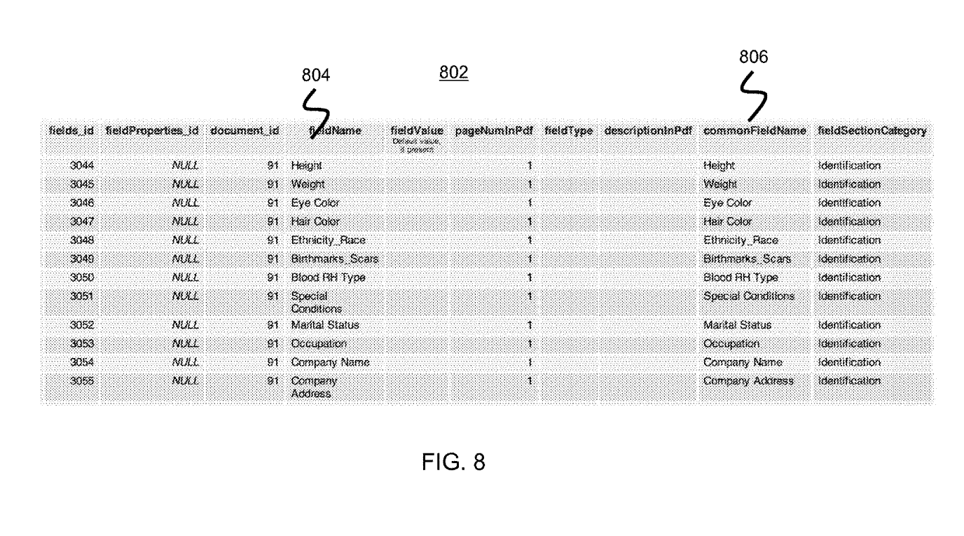

FIG. 7 illustrates a document library table 702, which stores a list of documents 704 that are stored in the system. The documents each are provided a document identification 706 (document_id), document title 708, and path 710 to the document in an associated database. FIG. 8 illustrates a database table 802, which stores the field names 804 of each document in the document library table of FIG. 7. Note that there is an option to set a default value for each field. For example, this year's tax form may have a default filing year of 2013. The commonFieldName 806 is a human-readable version of fieldName 804 in the cases where fieldName is obscure or poorly named by the original form designer. commonFieldName 806 allows the system to quickly match the field with field names found in a typical customer's vault. The commonFieldName 806 provides for more reliable and deterministic mapping of fields with field names found in a user profile.

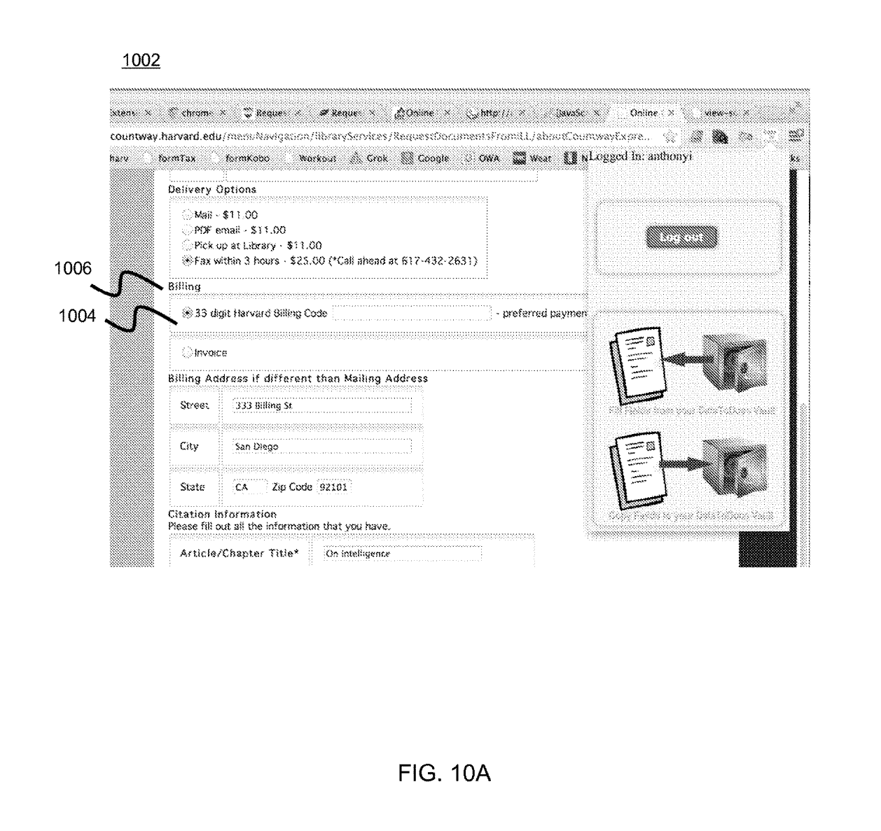

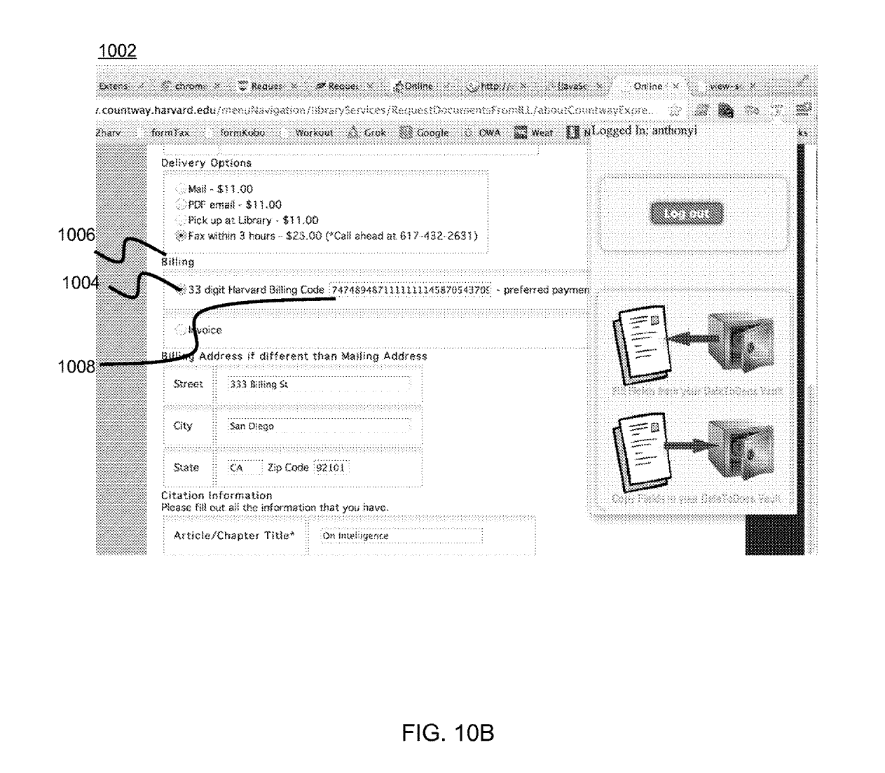

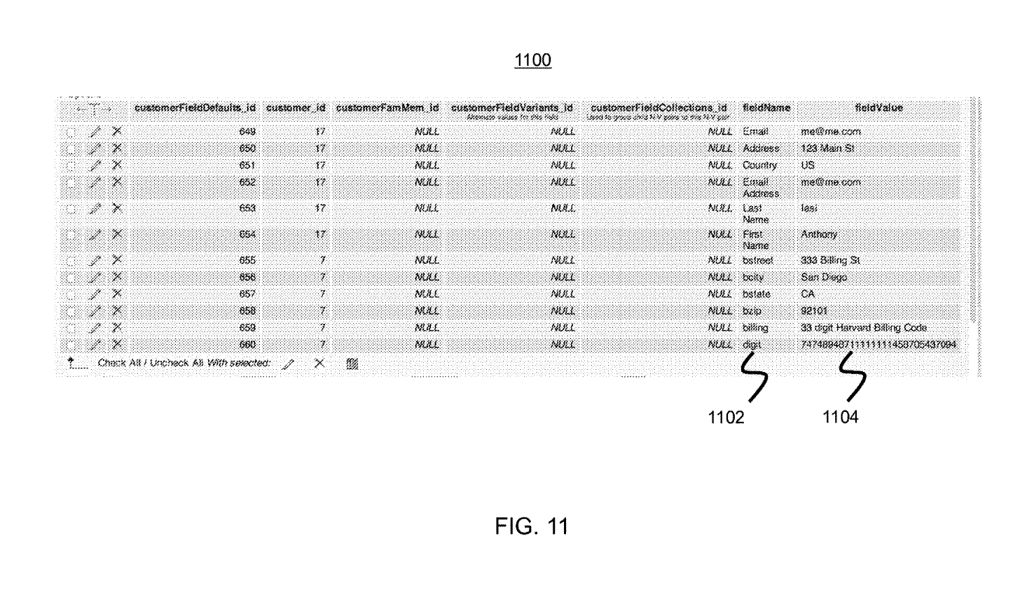

Unique field names and values are stored and organized in the system for future use. FIGS. 10A and 10B are illustrations of an online form 1002 with a unique billing code field 1004 in the “Billing” section 1006, which requires the field value to be a unique 33 digit code. If the user has not previously entered the code into the system (which is unlikely given that it is a unique code for a particular form), the user will be required to manually enter the field value 1008 in the field 1004 when completing the form 1002 for the first time, as shown in FIG. 10B. The system will pull the information on the field 1004 (and the value 1008 entered by the user in that field) into the system and list those in a database table 1100, as illustrated by the table in FIG. 11. As shown in FIG. 11, there are two entries created for this field, as one corresponds to the field name 1102 (digit) and one corresponds to the field value 1104 (the 33 digit number). In one embodiment, an additional line entry (not shown) is created to associate the radio button next to the field with the field and the field value. This will be useful when the form is being populated in the future, as the system will know to activate/select the radio button when filling in the field value.

In another embodiment, third party services and websites can provide information about forms and documents hosted on their own sites for storage on the system, such as the field names and other document or form-identifying information. Thus, if the user, is using the third party service and needs to complete a form or document of the third party service, the user can, request that the third party service obtain the user's information from the user data store for populating into the form or document at the third party site. The third party service can then maintain their customized form or document on their website or application, and the user can ensure that the content populated into the form or document accurately corresponds to the content needed for each field since the third-party service provided the field information to the system. Additionally, users are provided with additional security of the information, as the information is stored on the system data store rather than the third party service's data store, reducing the chance that the information could be stolen from the third party service or site.

In another embodiment, the third-party service can integrate the embodied system within their website or application so that information stored in the application or at a third-party server is shared with the system and used to complete forms and other documents. Similarly, the integration can provide for sharing of the user's information with the third-party site or application for completion of forms or documents at the third-party site.

Other sources of information may be used or envisioned, as would be apparent to one of skill in the art. As will be described further below, the information sources are used to build a profile of each user by collecting information of the user from the various sources and compiling the information into an organized list of information that can be used to populate fields or supplement information of any type and on any form.

### II. Organizing and Storing Information

The information obtained from the various information sources discussed above is used to build a user profile of an individual user, which ideally includes comprehensive information on the user's finances, contact information, health information and historical information. The user profile can include the user's name, birth date, age, current and past addresses, phone numbers, e-mail addresses, social security or government identification number, employment information (current and historical), salary, height, weight, race, bank account numbers, account balances, user names, passwords, education information, health risks, allergies, medications, etc. This list is by no means comprehensive. The user profile can also include information not directly related to the user, such as a name and phone number of an emergency contact person, family names and relationships, service provider contact information and notes, business contact information, business prospects, CRM, etc. The user profile can also store other metadata selected to the information or date to be stored.

Access to the system can be provided by an application interface through software running on a computing device such as a desktop or laptop, or through an application running on a portable electronic device such as a tablet or smartphone. Additionally, the system can be accessible over a web-based application interface, where all of the user's information is securely stored, e.g., in a secure server facility in a cloud-based network.

In one embodiment, the information can be stored in at least two or three separate data store locations that are purposely decoupled in order to provide enhanced security by minimizing the risk of hacking into one of the data store locations. The data store can be divided into a document library data store, which, e.g., stores form and document templates, field information and other form properties; a customer personal vault data store, which, e.g., stores the information that includes the fields and field values for each specific user; a user identity data store which, e.g., Stores information relating to the user's identity (separately from other information for security reasons) and a customer orders and completed documents data store that stores previously-completed forts in terms of the fields and values that were completed.

As will be described immediately below, the information will likely be classified into distinct categories so that it can be accurately populated or supplemented into an appropriate field of a form. Furthermore, as will also be described below, the potential risk of theft of such a wealth of personal information is mitigated by specialized proprietary encryption and storage techniques to prevent the information from being stolen or from being useful even if it is stolen.

### Field Mapping

Identifying which information belongs in which fields within a form is one of the most difficult challenges for populating forms. While many information fields contain names that easily and readily identify the value that belongs in that particular field, some names are ambiguously named, some fields have slightly differing names between different forms, some fields have identical names within the same document, and some fields have multiple values associated with the same field.

There are at least three primary circumstances where information needs to be filled in that drive the following field mapping techniques. In a first circumstance, a document library stores standard document templates that can be copied into a user's workspace and filled in on-demand. The document library would in this case store the document's fillable fields and possible default values in a “Fields” table. In a second circumstance, fields and values unique to each user are applied and mapped to blank documents. This set of unique user information will grow over time into a large vault of information. In a third circumstance, actual fields and values assigned to a document are filled in and saved by the user, such that the values are locked to a completed document. Some techniques for solving these problems are addressed below.

A first solution involves scanning the fields of a document and making associations and inferences as to a “best-fit” field name. In one embodiment, this is completed by utilizing the “for” attribute of a website field code that associates form labels with a field box on the page. For example, a field box with the ambiguous name “box00455x” may be encoded as “label for=′firstname,” so that we can associate the obscure name and the field with the label for “first name.”

For a situation where there are multiple fields in a document or forth the same or similar field names, the section of the document in which each field appears can be used to identify whether the values for each field should be different. The system data store can therefore store a “field section” entry as a category in the data store for each field, so that fields with the same name can be disambiguated based on which section they are in.

In some cases, a field name may be completely random and provide no indication as to how it maps to another field or a particular field value. The field names may be coded for another system that reads the specific codes with a computer and a specialized numerical or letter key code. For example, a “First Name” field may be named “fn0045586.” For PDF documents stored in the document library, an additional “helper” attribute can be added to the field record called “commonFieldName,” When the locum is inputted, the poorly named field can be manually translated to something that is easily mapped. For this “First Name” example, the system can record the FieldName record as “fn0045586” and the “commonFieldName” as “First Name,” When a user selects this document, our smart technology will recognize the commonFieldName and easily map that to one of the user's field names that best matches “First Name.”

In a situation where a user has multiple values associated with the same field name, the system call be configured to provide a drop-down menu or other selection method where the user can select which value to input into the particular field. In an alternative embodiment, the field is populated with the most recently-used value or the most frequently-used value.

In another embodiment, different forms can have different ways to refer to the same user field name. A document can name a field one way while another document names the same field another way. For example, a first document can have a field named “First Name,” while a second document may have a field named “fname,” and yet a third document has a field named “firstname”—all of which are referring to the same field and should contain the same value or content. To enable this association, a user FieldDefaults table in the system data store is provided with a “userFieldCollections” record that lists the various field names that are synonymous.

For example, over time there will be multiple fields stored in data store each containing the same value. For example, assume each of these 3 “first name” fields will all have the value “Arthur.” A background process executed by the field comparison unit 106d of FIG. 2 can periodically scan the data store for other fields with values of “Arthur” and identify those fields within the “userFieldCollections” table as duplicates. This table captures the various field names that are synonymous based on their common content. When any one of these fields is encountered in subsequent forms, the appropriate value of “Arthur” is used.

In a second approach, the system can pre-set the “UserFieldCollection” table with commonly-grouped field values. For example, “firstname” and “First Name” are stored into the table when the field called “firstname” is initially encountered. When a subsequent field called “First Name” in encountered, its value would have already been stored and easily located through the “userFieldCollections” table.

In one example, a problem occurs when there are commonly labeled field names for example a field name labeled “myFirstName” and another field (likely in a different form) labeled “customerFirstName.” Since these field names clearly correspond to the same information (user's name), in order to map “myFirstName” to “customerFirstName,” a machine learning classification library can be applied to learn from existing mapped fields from other users and then assign a recommended mapping between a user's field and a document's field.

### Identity Disassociation

In order to protect the user's information from potential theft and misuse, the system disassociates a user's identifiable information from their other information. For example, the user's name, social security number, birthday, employer identification, etc. is stored in a separate data store from the user's other information, such as their credit card number, bank accounts, education, grades, etc. The identifiable information is additionally stored without any logical connection to other identifiable information of the same user, such that each identity information field is effectively stored on its own island within the data store. Each item of user information can furthermore be encrypted individually and then stored in a table anonymously with other information, without any indexing, organization o grouping of the table, so that the table is unable to provide any useful information about a user on its own.

The encrypted information can only be decrypted with a key, and optionally in some cases, the key is individually generated for each separate item of information so that the key cannot be misused to unlock other items. The key is stored in a separate data store and can only be obtained when a user logs in with the correct password. Thus, by disassociating the information that makes up the user's identity, it is impossible to determine enough of a user's information effectuate identity theft simply from accessing the database and the tables listed therein. As an example a user's social security number (SSN) stored on its own and apart from other information (such as the user's name) is not useful for perpetuating identity theft. Given that the SSN is further encrypted into an unrecognizable series of letters and numbers, the system provides two highly-secure methods of protecting the information stored in the data store. In one embodiment, three separate data store locations are used to obtain information, and each location can be connected to the network using a separate server, which can be behind a separate firewall. A first data store can be configured to store the user's username and password. If successful in entering the username and password, a secret key is generated, which will then be supplied to a second location, which is solely used to store secret keys for each user. A third location can maintain the actual information and must be unlocked with the secret key from the second location in order to be read through an encrypted mapping to re-associate the islands of information.

### Automatic User Profile Updates

This type of disassociation, i.e., breaking up of the date into multiple pieces can, as described above, occur for each piece of information any well. In other words each piece of information can be broken into sub pieces, each separately encrypted with a unique key and/or stored in separate locations, without logical connections to other sub pieces. The system can be configured, in one embodiment, to automatically classify and store any inputted information into the user's, profile without requiring a specific indication from the user. Additionally, as user information will continue to be obtained during the user's normal activities, newly-input information will either act to update existing information or be added to a list of values for the same information field that the user can then select from when populating a form.

The user's information can be stored in its own data store location known as the personal information vault, and therein within a table called “customerFieldDefaults.” The customerFieldDefaults table will usually contain the most current information for the user.

### Deriving User Information

In one embodiment, existing user profile data can be analyzed to derive additional related information. The additional related information can be derived by performing comparisons or calculations of existing data, such as by analyzing financial data to determine a budget of regular income and expenses. In addition, the additional related information can be derived from external sources in order to provide the user with a more complete picture of certain aspects of their profile. For example, if a user enters a list of assets into their user profile that includes a vehicle year, make and model, the system can obtain an estimated value for the vehicle from an external data store or third party service. In another example, if the user enters the title of a collectable piece of artwork, the system can obtain additional information on the art, such as the artist, year produced and an estimated value. This information could be used to fill out an insurance application or a claim for the item in the event of a loss.

### Analyzing User Information

In one embodiment, the user activity collection unit 106e of FIG. 2 monitors user activity (such as information inputs, forms filled, etc.) when using the system and generates, collects and stores predetermined descriptive codes, based on their activity and information, into a separate data store locations. The codes may correspond to a user's current life status, demographic profile, preferences, financial balances, and other parameters that are associated with a user's account, but do not collect, disclose, or compromise their specific information. These codes can subsequently be used to determine targeted marketing and other strategies for that user for promoting third-party product and service offerings, which effectively better target their needs and desires for those products or services. The codes can also be provided with a confidence value relating to the likelihood that the code applies to the user based on factors relating to the type of form, the use of other related forms, etc.

For example, a user completing a college application can generate a code that relates to the likelihood that the user is about to enter college, which will then provide opportunities to market college-related products or services to the user. If the user completes a college application and a financial aid application, the confidence value relating to the code indicating that the user is about to enter college may jump higher. This can be used to present an advertisement to the user within the graphical user interface that is targeted to their life status, such as an ad for a college.

### Archiving of Populated Information

Each time the user populates information into a form, the system can save a reference to the final version of the form within a specific data store location table known as the customerFieldContent. Specifically, the form its entirety is not stored at single data store location. Rather, a reference to the form or a record locator is stored. The information stored in the firm can be locked and will not be updated as other user information is updated, unless the user specifically accesses the previously-completed form edits the form itself and creates a new version. The stored completed forms can be time and date stamped, to create a complete archive of the user's activities within the system.

### Shared Family Information and Group Plan/Company Plate Information

In one embodiment, the user's information cats be shared with other related parties that would like portions of their profiles to be shared. For example, spouses, children, parents, brothers and sisters and other family members can share similar information, such as addresses, telephone numbers, family history, etc. that will also be universally updated if one of the items is changed. This will provide convenience in avoiding entering repetitive information among family members and allow for global updates to shared information and allow family members to collaborate on an application, such as the FAFSA (Free Application for Federal Student Aid). The FAFSA application has certain sections for the Student to complete and other sections that Parents are required to complete. Another example is children applying for college can access shared family information that another sibling has already input into that sibling's user profile, such as addresses, parents' names, occupations, etc. Furthermore, if a family moves, an update to the home address by one family member can be updated or offered for updating across the other family members in the same group who also had an identical home address previously listed. Similarly, various employees of a company could collaborate in order to complete the company's government or other filings or reports; in another example, a database of health records for one generation of a family could be transferred to a second generation to provide information to the second generation about potential genetic health information.

To effectuate the family or company sharing option, information from each family/company member could be stored in a separate vault of the database, and the database would then form links between common information among the family/company members so that each member can maintain the privacy of their separate information.

### III. Populating Electronic Forms

### Selection if Stored Forms

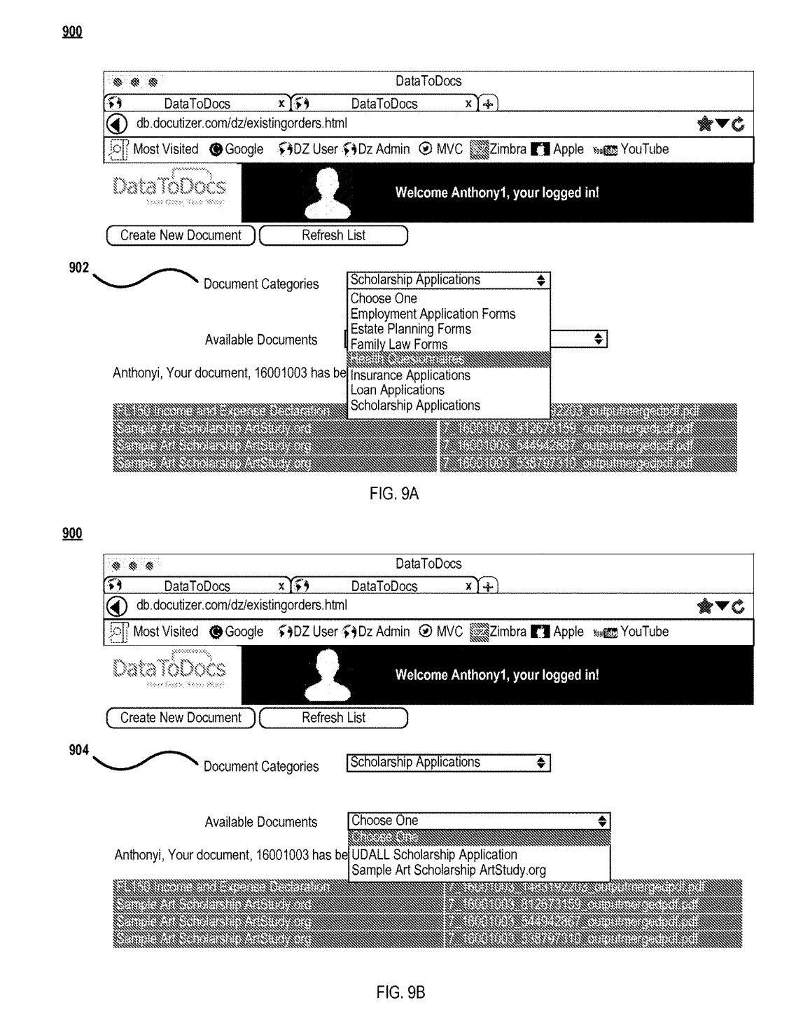

When the user is ready to complete a form or document, the user can select one of several methods. If the form or document stored in the forms database at the system server, the user can select the form from a list of document categories 902 or specific documents 904, as illustrated in the attached graphical user interface of a web-based application interface 900 in FIG. 9A and 9B. In addition, the user can be able to search for the form using a search tool or browse through the categories 902 to find the form based on the type of form (financial, academic, health care, etc.).

### Application Extension

In one embodiment, an application extension is provided for quick access to populate a form being viewed in an application window, as shown in the attached illustration of a graphical user interface of a browser extension drop-down to menu in FIG. 5. The extension can be displayed as an icon, menu item, supplement or otherwise in the application menus or elsewhere, and upon selection of the icon, a window opens with options to populate information from the user's profile to the fields displayed in the application window. The application can be an Internet browser, a word processor, image viewer, spreadsheet or presentation software, although these examples, as all examples and embodiments herein, are not limited hereto.

In another embodiment, as discussed in Section I, above, an application extension can also be used to extract information from or supplement a form, document or webpage being displayed in an application window. This extracted information can be uploaded to the user's personal information database.

In another embodiment, an application extension can also be used to display, and allow for modification of, user stored contact, CRM and/or contact related information related to form-fields recognized by the system while viewing a third party website such as on LinkedIn™. Facebook™ or Zillow™ websites. In one, example of this embodiment, a user is shown a pop-up or drop-down window while viewing one of their LinkedIn™ contacts which allows them to view, modify, directly add unique and private information about that particular contact back into their personal user database, without necessarily sharing that information with LinkedIn™ or the other users of LinkedIn™. Essentially, the user is augmenting the LinkedIn information with the user's personal notes on that contact, and securely storing that information for personal use in their information database. In another example, a user defined as operating a real-estate business is shown a pop-up or drop-down window while viewing a specific listing on Zillow.com™ which allows them to view, modify, or directly add unique and private information about that particular property back into their personal user database. This allows the real-estate business user to collect useful business information (e.g., the list of clients shown a particular property, listing details, showing schedules, etc.) which can enable them to be more effective in their business.

### Third-Party Application Integration

A third-party service provider can also incorporate access to the system into their own application, such as a web-based application or a mobile application running on a portable electronic device. For example, a website run by an academic institution can integrate access to the system into their application for applying for admission, such that upon loading the admissions application, the user can log in and then access their information to populate the admissions application directly through the website. In addition, an internet shopping website can integrate access to the system database so that when the user is ready to check out and purchase goods or services from the website, a button, link or authentication dialogue will be available for the user to select and then populate their information onto a payment screen.

The integration with the third-party application cat provide additional security to the user, as it can be configured so that the third-party service provider cannot view or store the user's information, and instead only requests it from the system database at checkout and then, deletes it once the transaction is complete.

The applications can be offered as standalone products or as web-based products and services. In one embodiment, the application can be offered as a portable document format (PDF) filler application, where the application operates to populate information in a PDF document. The PDF filler can be a web-based application or integrated as a browser extension, as has been previously discussed. The application can also be offered as a web-based form filler that is designed to complete forms and documents found online. Additionally, the system can be offered as a mobile application running on a smartphone, tablet or other portable electronic device that would enable a user to complete forms or other documents. With the difficulty of inputting information using small display screens and touchscreen devices, the ability to easily populate information with a portable electronic device is particularly advantageous. For example, users who are using their mobile device to make a purchase often find it difficult to enter all of their contact information and payment information on a small screen (in addition to having to remember it). The ability to instantly complete these ecommerce form fields will be particularly advantageous to the mobile user. In another example, a user visiting an urgent care or emergency room facility can be required to fill out several forms, and could instead be provided with a website to access the forms and utilize the inventive systems to populate the form fields and submit the form online. The mobile-based applications can be standalone or integrated into other mobile applications or native device applications. For example, in one embodiment, the system can be integrated with the camera of a portable electronic device, such that a user can take a picture of a blank form or document and utilize the system to populate the form fields before transmitting the completed document.

In another embodiment, a third party application can integrate with the system and the user profile to provide a partial or complete transfer of user profile data from the system to a third party user profile without requiring the user to view a form with the fields in the third party user profile. For example, a user who signs up for a third party service such as a social media service or an ecommerce service can be asked to complete a user profile simply by requesting that their user profile generated on the system be transferred to the third party application and corresponding server and database. The user can only need to select an option to instantly transfer all of their user profile information to the third party user profile without needing to view the web-based form corresponding to the user profile. The instant transfer can be completed by having the third party application send a list of field names to the server, which will then access the database tables to identify the value or values corresponding to the matching field names stored in the user profile. The matching field values will then be transferred back to the third party application server and database to complete the third party user profile.

Additional methods of transferring select user profile information automatically to another form, database, device or destination can be provided, and would eliminate the need for the user to manually review the form fields and content as it is being filled in or transferred to another location.

### Form Completion Indicator

In one embodiment, the user can be provided with a form completion indicator which indicates how much of a form can be filled from the information in the user profile. The form completion indicator can be displayed alongside a list of possible forms that the user is selecting from, so that the user can determine which form is easiest to populate based on the form completion indicator. The indicator can be a symbol, color or even just a numerical value indicating the percentage of fields in the form which will be filled in from information stored in the user profile. The form completion indicator will be updated in real time and help the user select a form from the forms database or an online web form which is easiest to automatically populate and has few manual entries. The completion indicator can also provide the user with an indication of how much of a given category has been mapped or how much work is required to complete the unfilled fields.

### Manual Input Interface

Although the system will populate any field for which it has information, certain fields can have no values or can have multiple values, in which case the field will not be automatically filled. In this situation, the user must take some action in order to populate the field. One embodiment for populating the form fields can be aided by voice, touch, gestures or an input device—or a combination of any of the three. The voice and touch input eliminates the need for any manual typing of any information being input into a form. Voice input can be utilized through a microphone on the computing device, while the touch and gesture inputs can be made through a touchscreen, touchpad, image capture device or motion capture device. The input device includes a mouse, stylus or other peripheral device connected with the computing device which permits a selection to be made on the graphical user interface.

In one embodiment, manual input of a value for a field can be completed by displaying a separate window, such as a pop-up or drop-down menu, with options for values that the user can speak, touch or select with the input device. The interaction can include one or more separate input types, such as touching the field on a touch screen to generate the window and then speaking the name of the desired value from a list of field values. Form input fields can also display windows with tips or annotations associated with the system database to assist users in completing a form. In one embodiment, a touch input on the field will initiate an input via voice, while a “touch and hold” input will initiate the display of the separate window with multiple possible values.

The need for manual input will arise whenever the user profile lacks a value for a field, or even when the system is designed to select a best-fit value from multiple possible values based on one or more criteria. The user can be provided with the option to manually input a value in a particular field if no value exists or in order to override the automatically filled value. For example, a user can list multiple different allergies in their user profile (i.e. eggs, bees and cats) such that a form field labeled “food allergies” can be too specific for the system to determine which value of the listed allergies should be automatically input. The system can use data from previous user entries by other users to determine that “eggs” is the most likely candidate. However, the user will then be provided with the option to select the field to generate the separate window and then select from the list of allergies in order to correct the selection—for example by adding “bees” or “honey” to the list if the user is allergic to food products made by honey. If the user has no field values stored for the field name “allergy,” the user can be prompted to manually input a field value with a physical keyboard or touchscreen keyboard interface, through selecting a category to provide a list of options in one or more drill-down menus, or by simply speaking the desired value and letting voice recognition software interpret the voice command and input the appropriate value. The user can also be able to speak a partial keyword for the form field which will then display the separate window with possible values that include the partial keyword. A lookup algorithm can be provided to associate keywords with possible related values.

As previously discussed, one application for a touch and voice input would be the ability to touch a specific form field and then speak the value that should be input into the field. Alternatively, the user can first speak the name of the field if the system cannot identify the field name, which will cause the system to populate the value for the spoken field name from the user profile. If no field value exists for the field name, the user could also then speak the value for the field. If the value entered is a new value, the system will store the value in the user's profile for future use. In one example, a user filling out an automobile insurance claim and needing to enter a vehicle identification number (VIN) can be able to touch the field box labeled “VIN” and then state “VIN number” or a similar command, after which the system database will populate the field with the stored VIN number. In another embodiment, selecting a value to populate in one field can also populate values in related fields. For example, during an eCommerce checkout phase, an on-line merchant prompts the user to input a credit card by displaying a field with such name. The user touches the field on their mobile touch-device and speaks the word “Chase Visa” and the user's Chase Visa card number, name on that card, card expiration date, and card security code (CSV) are all filled into the associated fields on the checkout form. The advantage to the user is that they need not store any personal credit card numbers with any on-line merchants, yet can still experience a speedy and secure shopping checkout. In addition, as user credit cards expire and are replaced or updated, there is no need for the user to remember to visit each merchant site just to update card changes as those are all stored in one location and securely on the system database.

In another embodiment, if a field has multiple possible values, the user can be able to touch or speak the field an and then touch, speak or select with a mouse input one of the list of values that is displayed in a drop-down menu or the like. Similarly, if multiple fields have the same name but are in different sections of a form, the user can speak the name of the section and then the name of the field in order to select a value for the specific field desired. Additional functionally includes the ability to touch or speak a form field and then search for values using keywords.

In addition to gestures, touch and voice inputs, the manual input of field values can also be made through specific types of movements in a device configured with a gyroscope or accelerometer which can detect directional movement and velocity. In one embodiment, a user can be able to shake the device (such as a smartphone or tablet) in order to have the user interface find or populate certain fields. For example, the user can shake the device to populate a blank form, and a more specific gesture such as a vertical tilt will find a particular field name and provide the user with a window and several options for field values to populate into the field name (such as a credit card field name and a list of different credit cards which the user can select from for electronic transaction).

In another embodiment, if an entire form, or if one or more fields in a form, have not been completely mapped and/or stored in the system, then the user can be able to touch or speak each unmapped field name and then touch or speak one of the list of categories, sub-categories, and specific category database fields to associate with this form field to the database field. The system can also collect and associate multiple user mappings of form fields to database fields using machine intelligence algorithms and then store the associated field mappings with the form into the forms database, thereby providing for an accurately mapped new form for use by all users of the system. This embodiment allows for system users to independently add, and map, new forms that are not currently in the system for the benefit of all system users. Additionally, it allows for system users to independently map web-form-fields to the database category fields for web-forms that have not yet had their fields mapped (associated) in the system for the benefit of all system users.

### Storing Modifications

In one embodiment, if the user manually alters a field value for a particular field after the system has populated the field, the system will denote the changed value and store the newly-input value in the system database, preferably in the information vault of the user's profile. The user can therefore update their profiles automatically while changing the information being input into a form.

### Methods and Applications

Although several applications for the systems and methods have been described above, the applications for the systems and methods should not be considered limited thereto. The systems and methods may be particularly applied for the completion of complex forms and documents which have a variety of form fields, require a significant amount of information or have similar or confusing names and field identifiers. College applications, loan applications, income and expense declarations for family law matters, health care forms and the many forms required for and by small business owners are potential applications that would provide significant improvements in time savings and accuracy of information (not to mention ease frustration or reduce redundancy) by use of the exemplary systems described herein.

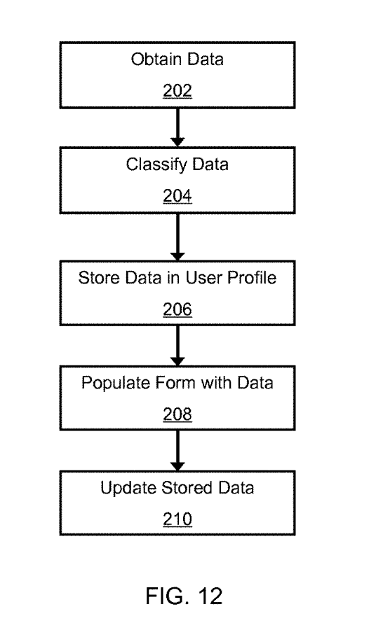

One embodiment of a method of obtaining, classifying and populating electronic forms is illustrated by the flow diagram in FIG. 12. In a first step 202 the information is obtained from one or more sources of information, such as existing forms, third party APIs, etc. The information is then classified in step 204 to determine at least one field to which the information belongs to and to associate the information with the at least one field. The plurality of associated information is then aggregated into a user profile in step 206 and securely stored in one or more databases. When a user requests that a form be completed through one of the client interfaces, the information in the user profile is matched with the form fields on the form and the information is populated onto the form in step 208. In step 210, if the user manually enters values into any form fields, and these values are different from the user's information as currently stored in their secure database, then these new values will be saved into the user's secure database. The user's profile can be optionally updated to reflect the new value as being the default or primary value for the field.

### IV. Computer-Implemented Embodiment

FIG. 13 is a block diagram that illustrates an embodiment of a computer/server system 1300 upon which an embodiment of the inventive methodology can be implemented. The system 1300 includes a computer/server platform 1301 including a processor 1302 and memory 1303 which operate to execute instructions, as known to one of skill in the art. The term computer-readable storage medium” as used herein refers to any tangible medium, such as a disk or semiconductor memory, that participates in providing instructions to processor 1302 for execution. Additionally, the computer platform 1301 receives input from a plurality of input devices 1304, such as a keyboard, mouse, touch device or verbal command. The computer platform 1301 can additionally be connected to a removable storage device 1305, such as a portable hard drive, optical media (CD or DVD), disk media or any other tangible medium from which a computer can read executable code. The computer platform can, further be connected to network resources 1306 which connect to the Internet or other components of a local public or private network. The network resources 1306 can provide instructions and information to the computer platform from a remote location on a network 1307. The connections to the network resources 1306 can be via wireless protocols, such as the 802.11 standards Bluetooth® or cellular protocols, or via physical transmission media, such as cables or fiber optics. The network resources can include storage devices for storing information and executable instructions at a location separate from the computer platform 1301. The computer interacts with a display 1308 to output information to a user, as well as to request additional instructions and input from the user. The display 1308 can therefore further act as an input device 1304 for interacting with a user.

### V. Additional Features

Certain embodiments disclosed herein provide methods and systems for secure storage and management of data, credentials and encryption keys, specifically including client endpoint protection. After reading this description it will become apparent how to implement the embodiments described in various alternative implementations. Further, although various embodiments are described herein, it is understood that these embodiments are presented by way of example only, and not limitation. As such, this detailed description of various alternative embodiments should not be construed to limit the scope or breadth of the appended claims.

Co-pending U.S. patent application Ser. No. 14/863,294 (the '294 Application), the disclosure of which is incorporated herein by reference in its entirety as if set forth in full. The '294 Application describes systems and methods for secure high speed data storage, access, recovery and transmission that involves fragmenting, individually encrypting and dispersing of the data as described therein. For example, as described in the '294 Application, data in a medical record can first be disassociated so that, e.g., the various fields are not logically related. Then the disassociated fields can be decomposed into sub-fields or parts (fragments). These sub-fields can then be obfuscated such that one cannot easily determine the contents of the sub-fields, even if they were to intercept or gain access to them. These sub-fields can then be individually encrypted, e.g., using a different encryption key for each sub field or fragment. The individually encrypted, sub fields can then be “sharded” and stored on different storage devices or locations.

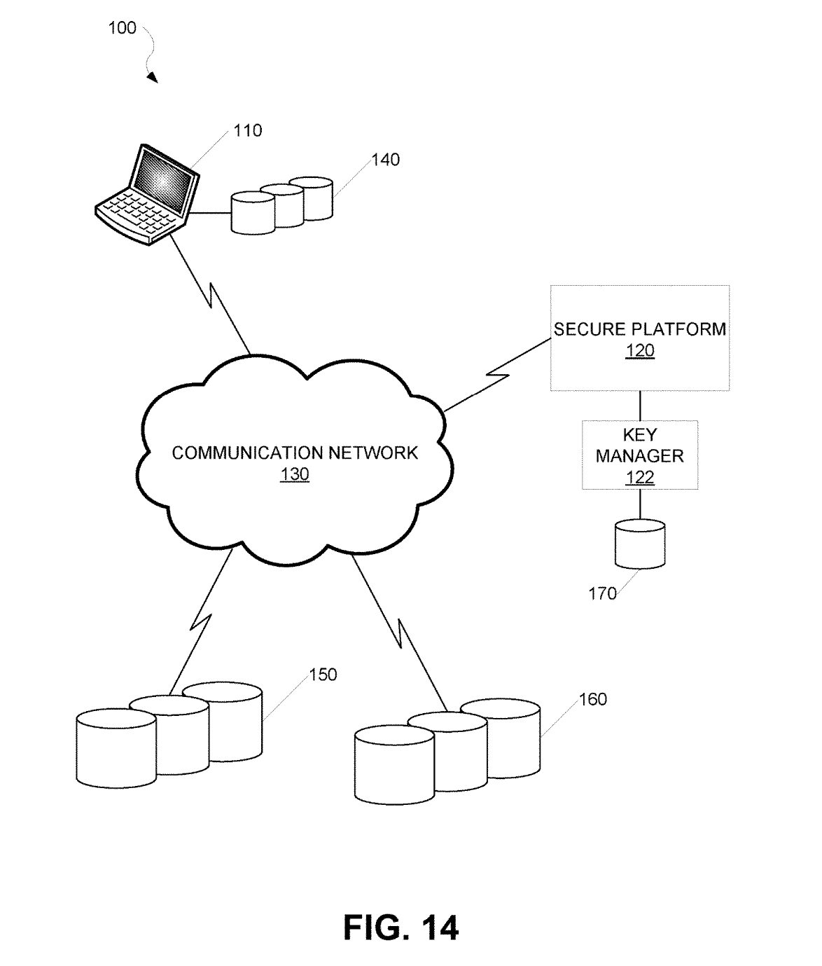

FIG. 14 is a reproduction of FIG. 1 of the '294 Application illustrates an example system on which the process described can be carried out. But as described, with reference to FIG. 14, the process generally occurs on secure platform 120 in response to a command or request initiated on client device, or endpoint 110. The secure platform 120 then stores the encrypted fragments on various storage devices or locations 140-170. While location 140 can be local or locally connected to device 140, the processes described in the '294 Application do not necessarily cover the link from endpoint 110 to platform 120.

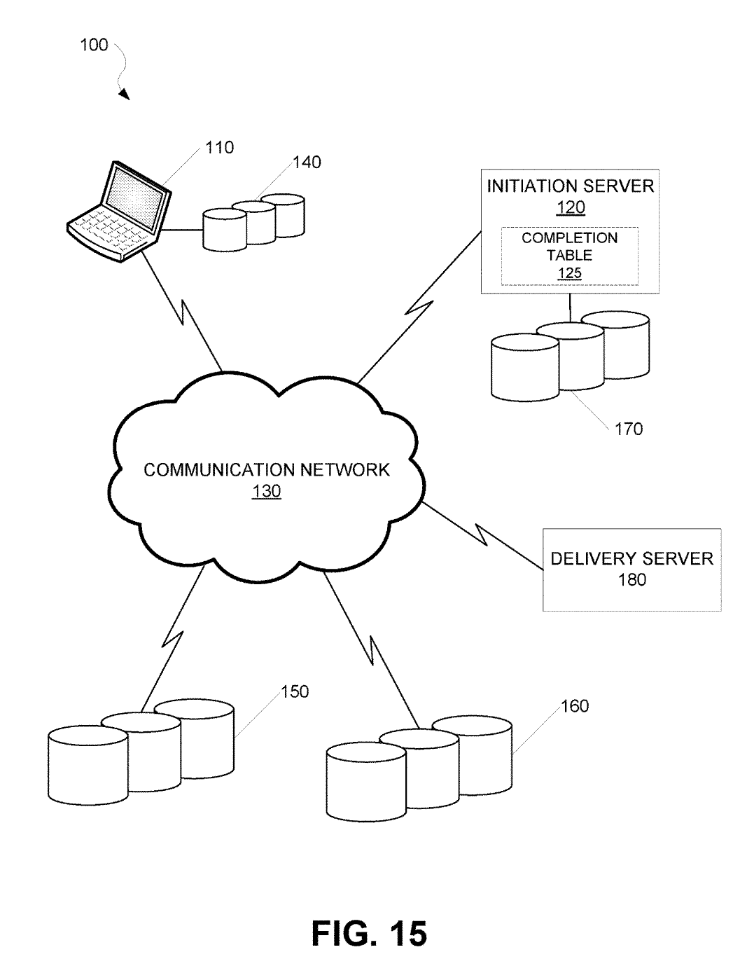

Co-pending U.S. patent application Ser. No. 14/970,466 (the '466 Application), the disclosure of which is incorporated herein by reference in its entirety as if set forth in full and describes systems and methods for diffracted data retrieval of data that has gone through the processes of the '294 Application. FIG. 15 is a reproduction ref FIG. 1 of the '466 Application which illustrates a system for carrying out the diffracted data retrieval described therein. As described with reference to FIG. 15, the diffracted data retrieval can involve storage device or location 140 which is local or locally connected to endpoint 110, the processes described therein generally do not apply to the link between endpoint 110 and servers 120 and 180.

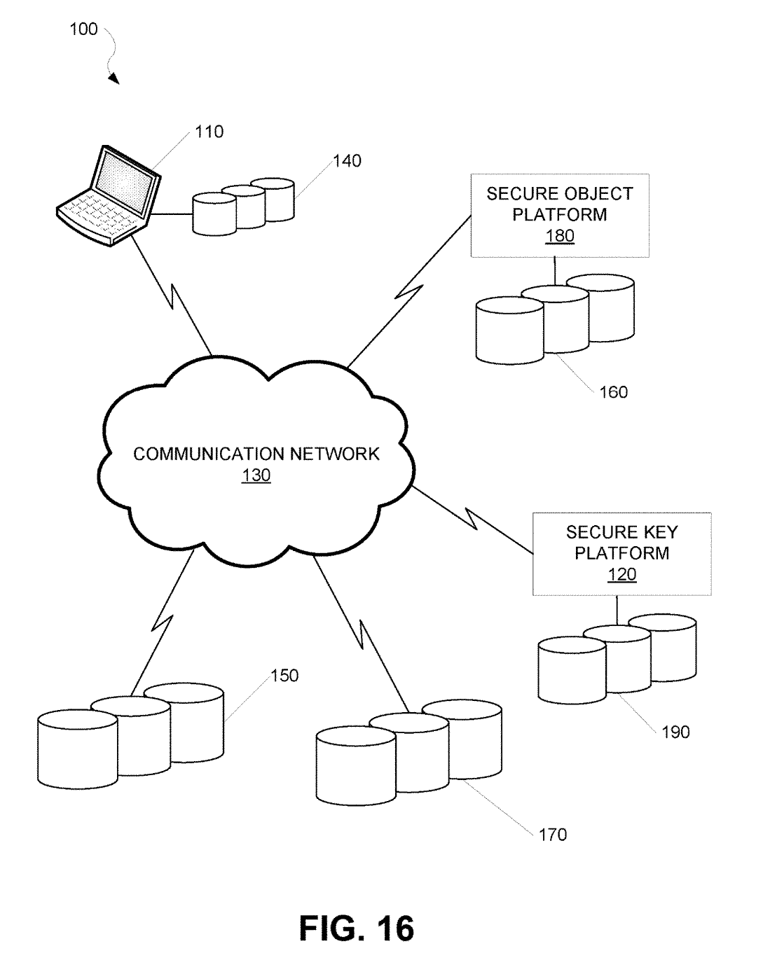

U.S. Provisional Patent Application Ser. No. 62/281,097 (the '097 Application), now expired, the disclosure of which is incorporated herein by reference in its entirety as if set forth in full. The '097 Application describes systems and methods for secure storage and management of credentials and encryption keys. FIG. 16 is a reproduction of FIG. 1 the '097 Application hitch illustrates a which the processes described therein can be carried out. As described with reference to FIG. 16, while the secure storage and management of credentials and encryption keys can involve storage device or location 140 which is local or locally connected to endpoint 110, the processes described therein generally do not apply to the link between endpoint 110 and servers 120 and 180.

In the systems and methods described herein, the process described in the '294, '466, and '097 applications can be implemented at the edge, i.e., on client endpoint 110 as illustrated in FIGS. 14-16. For example, an application can be loaded to device 110, such that data can be saved to and retrieved from different portions of local or locally connected storage device 140 as described in the Attachments or such that the data can be saved and stored to a plurality of storage devices 140-170. Thus, if the user of device 110 creates a document, video, picture, etc., the user can invoke to the application to store the document or file. This can involve doing all the steps described above and in the Attachments to store the fragments in a dispersed manner to different locations in storage device 140 or to different locations on memories 140-170 as described above and, e.g., in the '294 Application. Similarly, the application can perform the diffractive retrieval of the data or file as described in '466 Application, and can enforce the management of credentials and encryption keys as described in '097 Application.

Thus, when the data is saved to a plurality of storage devices, the transmission of that data to those devices is also secured via the fact that the process separately encrypted all the fragments prior to transmission for storage. In other words, the data elements are all fragmented and secured at the device before they are transmitted. A major benefit of this is that the communication channel does not need to be secured and an ordinary “open” connection can be used. For example, instead of using the slower and more expensive TLS secured browser transmission, a faster non-encrypted channel may be used. The data packets will contain secured fragments. This applies to all types of transmission, not just browser based: could be radio, FTP, Bluetooth, etc.

The application can be presented as button in a toolbar or drop down menu such that when the user is in a document or file on their device 110 as illustrated in FIGS. 14-16, they can simply press the button, icon, etc., in the associated application or in a web browser and the document can be stored accordingly. The document or file can then be shown on device 110 in a manner that indicates that it has been stored using the processes describe above and in the '294, '466, and/or '097 applications. When the user accesses the document or file again, the retrieval process described above and in the '294, '466, and/or '097 applications can automatically take place. In certain embodiments, the user can also select various dispersion preferences as to where all, or some of the fragments are stored.

In other embodiments, e.g., a right click on a file can be used to select the storage processes described. In still other embodiments, the application can automatically determine that a file should be stored using such processes. In still other embodiments, the default for all files, certain files, certain types of files, etc., can be set to use such processes.

Often, a user of device 110 as illustrated in FIGS. 14-16 will ultimately want to use some form of remote storage, often referred to as cloud storage to store at least some of the files created on device 110. An application(s) running on a server(s) associated with such a cloud storage service can be configured to perform the processes described in the '294, '466, and/or '097 applications in a manner similar to that described in, e.g., the '294 Application. But as noted above, the link between device 110 and such a server would not necessarily be secure however, as described herein, the processes described can first be run on the content locally prior to transferring the data to the cloud, or an intermediate endpoint. There could be many intermediate “endpoints” before ultimately making it to, for example, the cloud. The single-client to cloud is just one topology. For example, there could be a network of nodes all communicating with each other each using the systems and methods described to secure their data before transmission. Then the fragments can be stored in a dispersed manner on the cloud service. Thus, even if the data were to be intercepted in transit, it would be useless.

In certain embodiments, the application can be configured such that it automatically performs the processes described when the user attempts to store or retrieve data from a cloud storage service. Moreover, the application can be configured such that a document or file at rest, i.e., no interaction with the document or file for a certain period of time, is detected and the processes described are then automatically run to protect the document. When the user then re-engages with the document or file, the appropriate processes can be run to allow access to the document or file.

In certain embodiments, the processes described can be performed locally on, e.g., a file, and then performed again as the file is being transferred to, e.g., the cloud and/or intermediate device.

In certain embodiments, sharing and collaboration of documents stored using the processes described can enabled using the authentication and credential management processes described, e.g., in the '097 Application. Thus, certain individuals can be granted access, which would then be managed using the secure keys generated, e.g., based in the credentials assigned to those individuals.

Another important benefit inures from the processes described when local storage is an unsecure storage device such as a USB drive. In such a case, storing data to the device using the processes described can ensure that even if the data is accessed by the wrong individual or entity, it cannot be used. It should be noted that in certain embodiments, the local application configured to perform the processes described at the local level can reside on such a local storage device, e.g., a USB storage device.

In certain embodiments, the local application can also be configured to provide protection of email attachments. Sending attachments via email is dangerous as attached documents can be intercepted and read by any hacker with enough knowledge. The processes described herein can be implemented with respect to such attachments in such a way as to protect them from being read by anyone other than the intended recipient. Generally, the local application does not interface with email traffic or encrypt the body of the email itself. Rather, a sender of an attachment with the local application can run the processes described on the document they intended to attach (thereby sending it to a public cloud server). The application can then generate an access link to that document. The access link can then be emailed to a recipient instead of the actual document. The recipient can then click on the access link they received to download and decrypt the original document. This of course an require that the recipient also have such a local application to allow the recipient device to retrieve the attachment according the processes described.

In other embodiments, a local application such as described above can also allow for a controlled sequenced “viewing” or “playback” of digital media (documents, books, audio, video, etc.) frames or sections. In such embodiments, an authorized and authenticated subscriber, or user of a device 110 as illustrated in FIGS. 14-16, is only able to retrieve and view separate sequential frames or sections that have been transmitted to them as the media is being displayed (or played). Additionally, after the subscriber proceeds to the next frame or section, the previous played frames or sections are either auto re-stored using the processes described or permanently deleted. Therefore, at any one instance, only a minimal amount of digital media is decrypted and assembled for subscriber consumption thereby minimizing piracy or unauthorized consumption. This can optionally be extended to also limit the amount of sequential frames or sections that are authorized for further transmission from the transmitting source to the authenticated and authorized subscriber through a consumption feedback mechanism back the transmission source. The value is for more safely distributing digital media of all types, from consumer to top secret data.

Thus, prior to transmission, such digital media can be broken-down into self-contained sections or frames, and then the processes described of fragmenting/encrypting/dispersing each of those sections or frames is applied prior to transmission to an edge device 110 as illustrated in FIGS. 14-16. Upon retrieval, each section or frame can be transmitted at a time in a sequential technique to recompose the underlying fragments making up that section or frame.

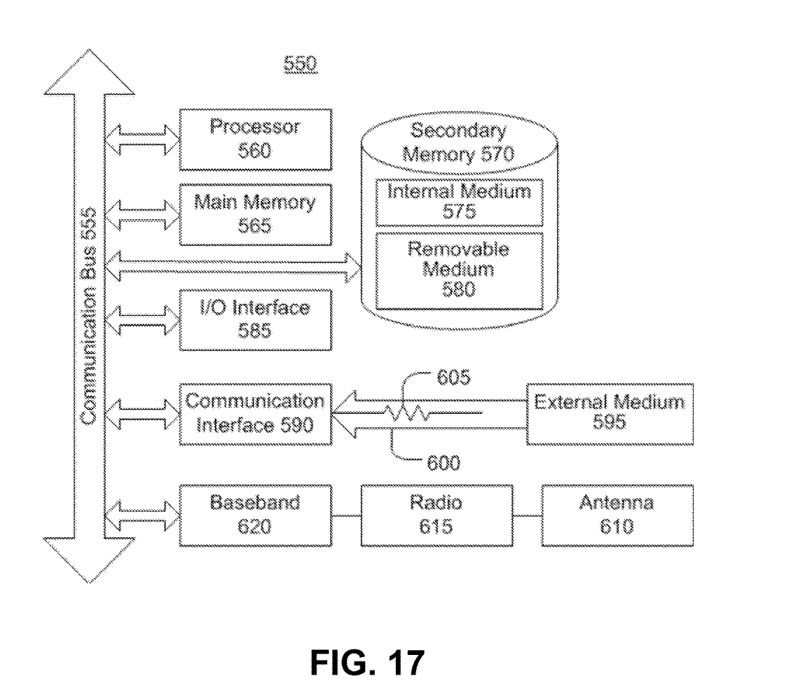

As is noted therein, FIG. 4 of the '097 Application, reproduced herein as FIG. 17, is a block diagram illustrating wired or wireless system 550 according to various embodiments that can be used to implement the client device 110 as illustrated in FIGS. 14-16. Accordingly, this system 550 will not be described here in detail.

### VI. Key Exchange Methodologies

When a new device (such as an IoT device) is added to a network, there needs to be a way to authenticate that device. Various aspects of the present disclosure provide methods for integrating any number of key exchange methodologies, including the built-in key exchange process of the device, to facilitate this operation. This capability enables authenticated communications between two devices, for example, in the case of data streaming between those devices. Once communication is established between the two devices, the key exchange methodology and frequency of exchange may be dynamically varied based on performance requirements and in response to any number of conditions, for example, but not limited to, data security threat levels. An encryption engine may dynamically interoperate and layer with other key exchange solutions including private/public exchange, for example, but not limited to the Diffie-Hellman protocol used in TLS, between devices. Higher levels of security may be achieved by.

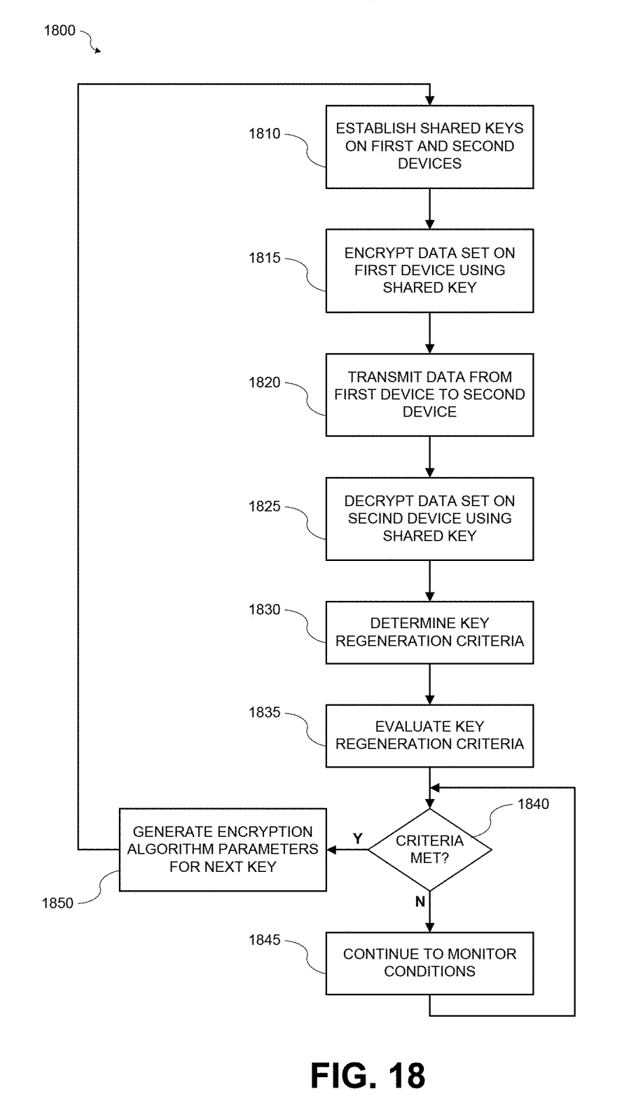

FIG. 18 is a flowchart illustrating a method 1800 for exchanging keys in accordance with various aspects of the present disclosure. Referring to FIG. 18, at block 1810, based on the current encryption algorithm parameters and seed, each device, for example, a first device and a second device, may establish a shared key. One of ordinary skill in the art will appreciate that more than two devices may be utilized without departing from the scope of the present disclosure.

At block 1815 a dataset on the first device may be encrypted using the shared key and at block 1820 the first device may transmit the encrypted data to the second device. At block 1825 the second device may decrypt the dataset using the shared key. At block 1830 key regeneration criteria that indicate whether the keys should be regenerated may be determined. At block 1835, the key regeneration criteria may be evaluated for each data set. At block 1840, it may be determined whether the key regeneration criteria are met. In response determining that the key regeneration criteria are not met (1840-N), at block 1845 conditions that indicate when keys should be regenerated may be monitored until the key regeneration criteria are met at block 1840. In response to determining that the key regeneration criteria are met (1840-Y), at block 1850 new encryption algorithm parameters for the next key may be generated and the method may continue at block 1810. The key regeneration criteria may identify possible encryption algorithms and specific parameters for the encryption algorithms.

### VII. Encrypted Data Transmission

In accordance with various aspects of the present disclosure, encrypted data may be transmitted with unique encryptions through multiple simultaneous client destinations including, but not limited to, streams, filesystems, and/or clouds. Encrypted data may be directed to any number of destinations such as a stream format decrypted to a video player, or as a set of fragments stored securely on a filesystem or cloud. The item to be encrypted can be in any number of data formats including, but not limited to, files (e.g., Word documents, photo files, virtual machine files, etc.), key-value pairs (e.g., simple strings such as JSON or other formats suitable to store form data, application settings and preferences), and streams (e.g., video or data feeds).

In accordance with various aspects of the present disclosure, each object may be disassembled into smaller fragments enabling a reduction in the total transmission time, T, for each object, in some cases enabling transmission times up to 8-15 times faster than conventionally available. Fragments of an object may be encrypted only once while increasing security by utilizing unique keys for each client. This approach may provide a performance advantage even while sending encrypted data to multiple client destinations. Each destination may have a unique decryption key to access the data. Multiple secure output streams to multiple destinations may be created while minimizing hardware resource demands. Fragmenting, encrypting, and transmitting data between computing devices can achieve low latency and full data encryption. In accordance with various aspects of the present disclosure, the approach may be scaled to support multiple clients maintaining a unique secret key between each client and encrypting the manifest differently for each intended client.

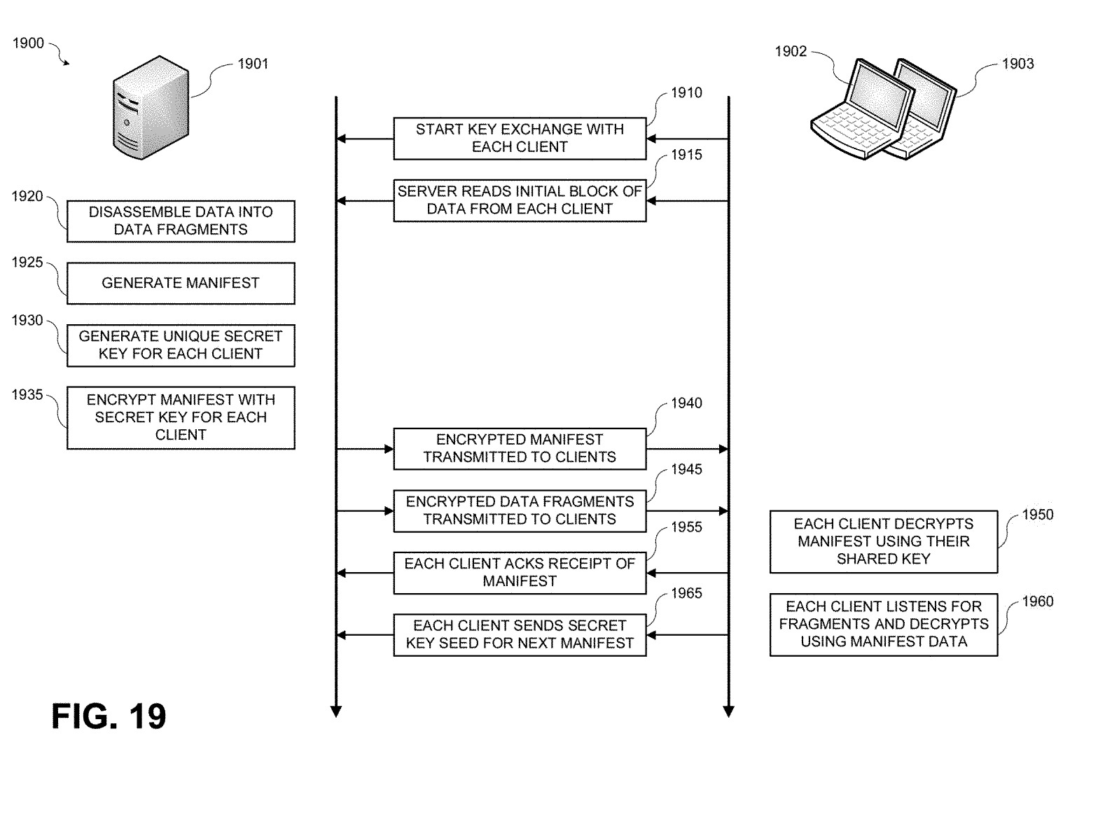

FIG. 19 is a sequence diagram illustrating an encrypted data transmission sequence 1900 in accordance with various aspects of the present disclosure. Referring to FIG. 19, at block 1910 client software running on each client 1902, 1903 communicates with the server 1901 and starts a key exchange process. At block 1915, the server 1901 reads a block of data, for example, one frame of a video stream, a sample of audio, etc., from a source which could be a file or data sensors including, but not limited to cameras, video, and/or audio sensors. At block 1920, the server 1901 disassembles the data creating data fragments. At block 1925, the server generates a manifest for each of the clients 1902, 1903 which contains, among other data, unique encryption keys for each of the data fragments. At block 1930, the server 1901 uses the key exchange information from each client 1902, 1903, to create a unique secret key for each client 1902, 1903. At block 1935, the server 1901 encrypts the manifests using the unique secret key for each client 1902 1903.

At block 1940, the server 1901 transmits the encrypted manifests to each of the clients 1902, 1903. One of ordinary skill in the art will appreciate that different data may be transmitted to each client 1902, 1903 and therefore a different manifest may be generated and transmitted by the server 1901 to each of the clients 1902, 1903. The server 1901 encrypts the data fragments and at block 1945 transmits the encrypted data flag gents to the intended clients 1902, 1903. At block 1950 the client software running on the clients 1902, 1903 awaits receipt of the manifest and decrypts the manifest using the unique secret key. At block 1955, each client 1902, 1903 acknowledges receipt of the manifest to the server 1901. At block 1960 each client 1902, 1903 listens for encrypted data fragments and decrypts each data fragment using data contained within the manifest. At block 1965, each client 1902, 1903 sends a secret key seed for the next manifest to the server 1901.

The sequence of FIG. 19 may be repeated for each block of data read from a client. The data fragments may be received by the clients in any order and will be reassembled and processed in the correct order. The server may repeat the sequence for the next block of data all beginning at block 1920. For each block of data the client will await the receipt of the corresponding manifest. If the server does not receive a manifest acknowledgment from the client, the server will withhold the next block of data until an acknowledgment is received or until a timeout interval has expired. If a client receives an incomplete or inaccurate manifest the server may be notified to resend the current manifest encrypted with a new secret key. If a client receives incomplete or inaccurate data fragments, the server may be notified to resend the current block of data.

### VIII. Data Encryption Speed

In accordance with various aspects of the present disclosure, a preprocessor may pre-slice or break up a large file into smaller pieces prior to the fragmentation and encryption processes. A companion post processor may recombine the file subsequent to decryption and defragmentation. By disassembling data objects into smaller fragments and encrypting those individual fragments across multiple processor threads a speed advantage (e.g. 5X-15X) may be gained without reducing the key size or otherwise compromising the security level. “Slicing,” i.e., breaking up a large file into smaller pieces prior to fragmentation and encryption and then recombining them after defragmentation and decryption, can increase performance and permit processing of very large data objects on devices that have limited memory.

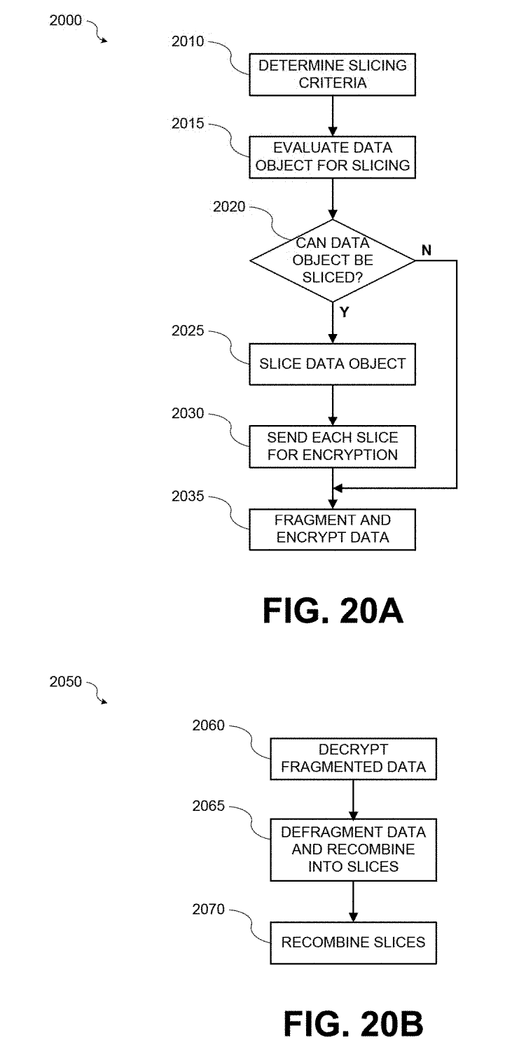

FIG. 20A is a flowchart illustrating a method 2000 for pre-slicing data to increase encryption speed in accordance with various aspects of the present disclosure. Referring to FIG. 20A, at block 2010 data slicing criteria may be determined. At block 2015, a data object may be evaluated for slicing based on the determined slicing criteria. At block 2020, it may be determined whether the data object can be sliced. In response to determining that the data object can be sliced (2020-Y), at block 2025, the server may break up or “slice” the data object into smaller pieces of data, and at block 2030 each data slice may be sent encryption. At block 2035, the server may disassemble each data slice into data fragments and the data fragments may be encrypted. The data may be disassociated and dispersed for storage in one or more storage locations.

FIG. 20B is a flowchart illustrating a method 2050 for recombining a data file in accordance with various aspects of the present disclosure. Referring to FIG. 20B, at block 2060, encrypted data fragments may be decrypted. At block 2065 the decrypted data fragments may be defragmented and recombined into data slices. At block 2070, the slices may be recombined into the data object.

### IX. Encryption Key Management

In accordance with various aspects of the present disclosure, the system may distribute keys to key stores residing within a local operating system. In some cases, for example, in the case of a network outage, a device may not be able to access the remote user and key or similar license service. The remote service may be used to verify the user's license credentials such as username and password at the time of login. In such cases where the remote service is unavailable the client software may validate the user credentials locally by accessing the encrypted key store on the local device. The system may populate and manage this local key store as a backup for resiliency against network outages.

The system may deliver key management (KM) software including all of the expected state of the art capabilities. However, when communication to the key management server is lost not because the key management server is down, but because the remote device is not able to connect to it as result of a network outage or some other connection problem. Given a scenario where the system client software is running on a device such as a laptop or other network enabled computing device and the connection to the key management server is lost, the client software continues to encrypt/decrypt data on that device. The client software will generate a local key store on the operating device as a backup in case the remote key management server connection is lost. The local key store can be configured to maintain the specific keys or key encryption keys needed by the user including any additional user credentials required. The key store itself may be encrypted and only available to the authenticated user.

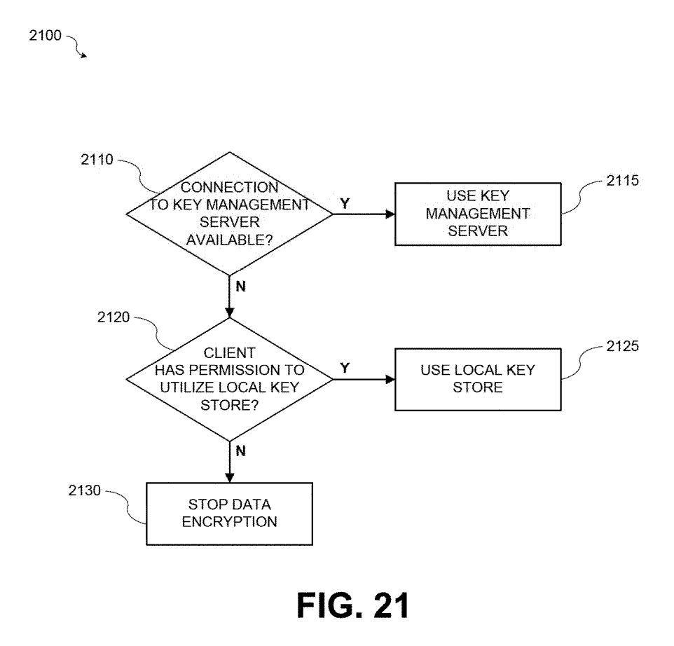

FIG. 21 is a flowchart illustrating a method 2100 for managing encryption keys in accordance with various aspects of the present disclosure. Referring to FIG. 21 at block 2110, it may be determined whether a connection to a key management server is available. In response to determining that the connection to the key management server is available (2110-Y), at block 2115 a client may communicate with the key management server to access encryption keys.

In response to determining that the connection to the key management server is not available (2110-N), at block 2120 it may be determined whether the client has permission to utilize a local key store. In response to determining that the client has permission to utilize the local key store (2120-Y), the client may access encryption keys from the local key store. In response to determining that the client does not have permission to utilize the local key store (2120-N), at block 2130 data encryption may be stopped.

### X. Compound Security Keys

In accordance with various aspects of the present disclosure, user and key technology may support compound keys using AND/OR Boolean logic. The system extends the concept of compound keys by introducing a dynamic expression to control the key's access requirements. A compound key can be defined using any number of sub keys. In order for the compound key to be valid, the integral sub keys should be all present and correct (Boolean AND), or at least one of the sub keys should be present and correct (Boolean OR). There may be any combination of Boolean constructs used to define a valid key.

In accordance with various aspects of the present disclosure, a dynamic expression may be used to control a key's access requirements. Keys may have any combination of Boolean expressions to limit or control a key's capabilities. For example, a key's access expression may be described as (Alice AND (Bob OR Carl)) and only allow Alice to unlock a file if done in concert with either Bob or Carl. Compound keys may also incorporate an unlimited variety of other conditionals, not just user names, including geo location, clock, time, and hash checksums. For example, (Alice AND (Bob OR Carl) AND ACCESSTIME IS EQUAL BUSINESSHOURS) may add a restriction to business hours only. Furthermore, key access expressions play incorporate dynamic conditionals that may change based on external conditions for example, but not limited to whether security threat levels are high. For example, (Alice AND (Bob OR Carl) AND SECURITY IS EQUAL (NORMAL OR LOW)) may only allow access when security conditions are at normal or low levels. These expressions allow highly responsive access controls to automatically keep data secure even as conditions change fast as during a hacker attack. One of ordinary skill in the art will appreciate that other combinations may be used without departing from the scope of the present disclosure.

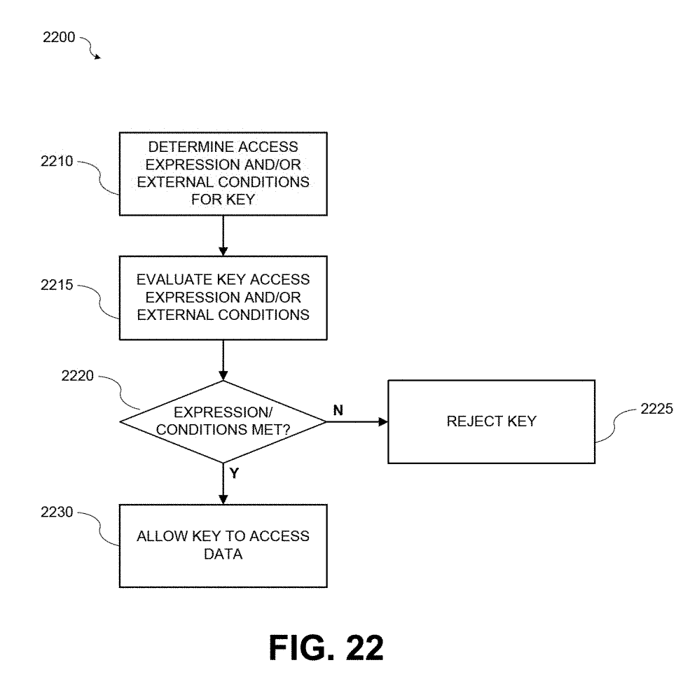

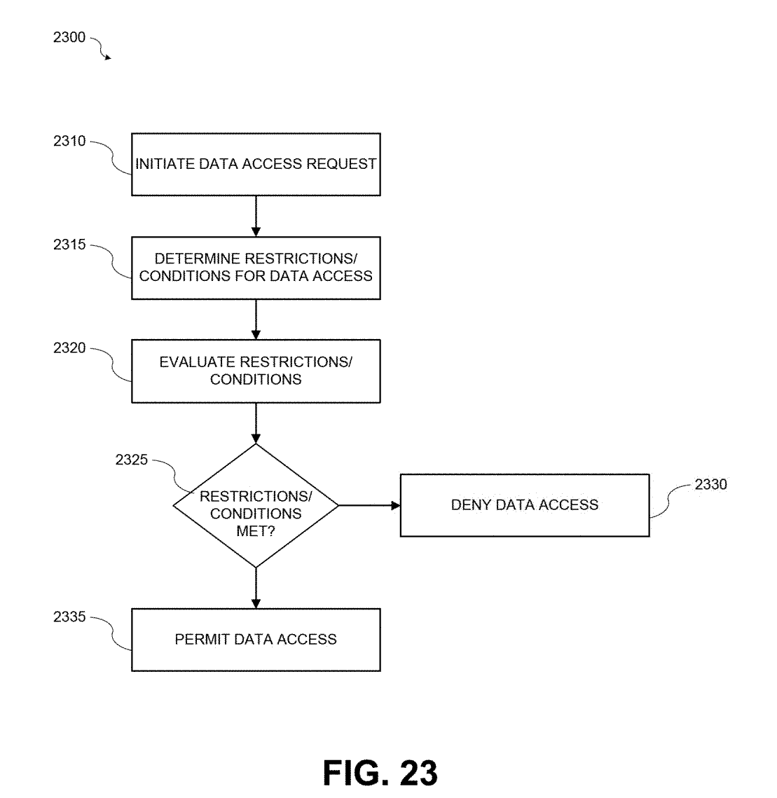

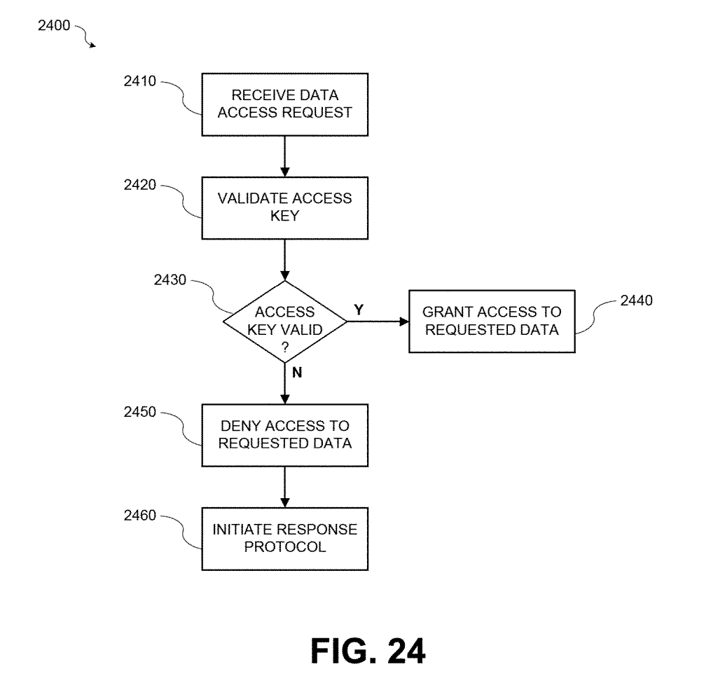

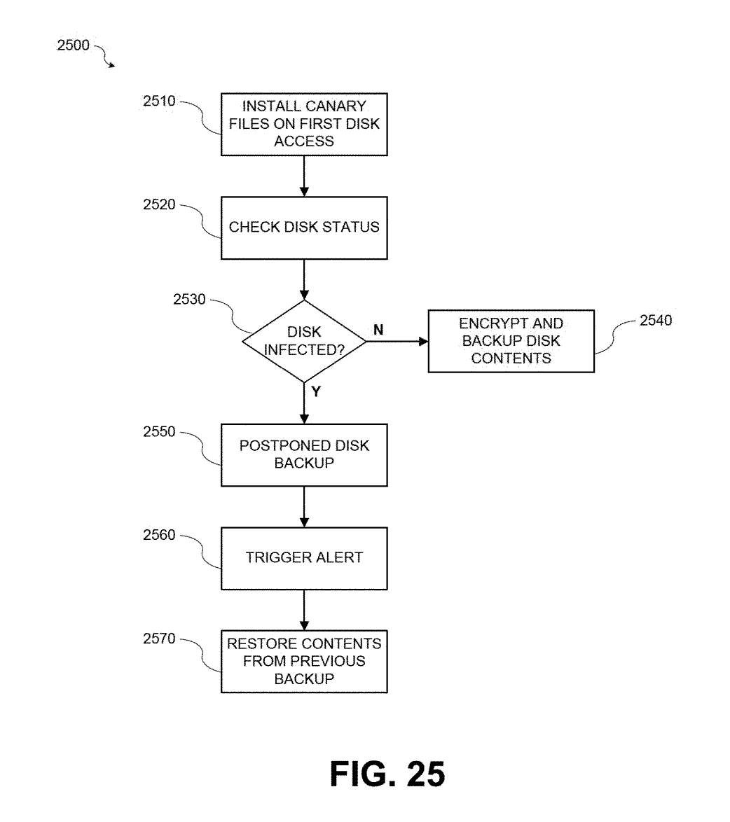

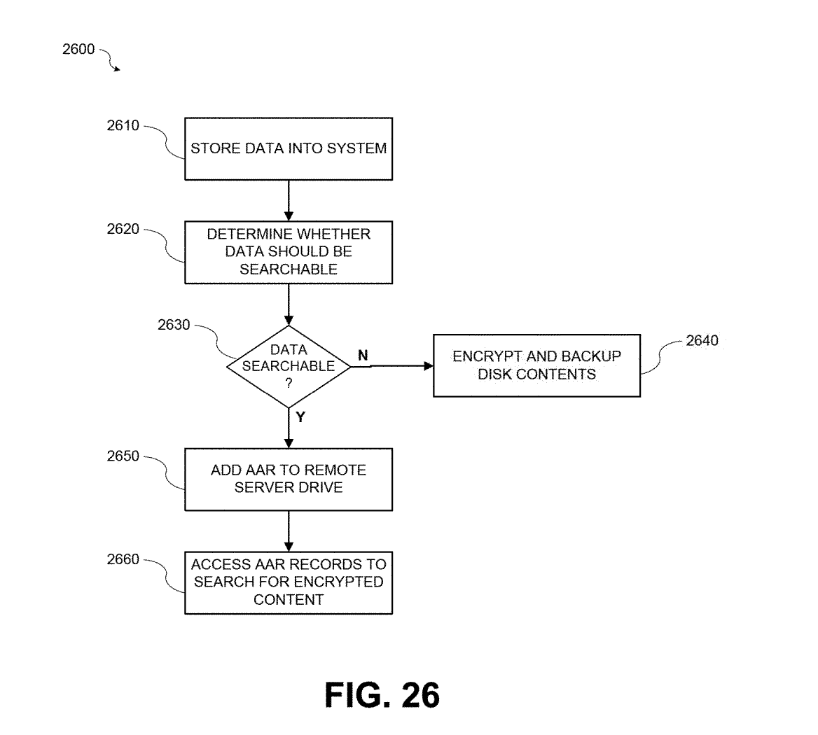

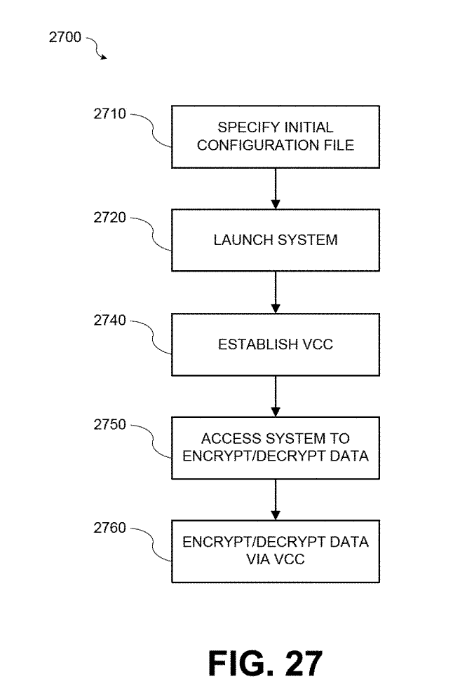

FIG. 22 is a flowchart illustrating a method 2200 for evaluator a compound key in accordance with various aspects of the present disclosure. Referring to FIG. 22, at block 2210, for each attempted data access, and access expression for a security key may be determined. For example, the access expression may include any combination of Boolean expressions and/or external conditions. At block 2215, the access expression for the security key, including any required external conditions, may be evaluated. At block 2220, it may be determined whether the access expression and/or external conditions are satisfied.

In response to determining that the access expression and/or external conditions are not met (2220-N), at block 2225 the security key may be rejected and data access may be denied. In response to determining that the access expression and/or external are met (2220-Y), at block 2230 the access key may be accepted and data access permitted.

### Data Access Restriction

In accordance with various aspects of the present disclosure, encrypted data may include any number of access restrictions including but not limited to user roles, compound keys, geo location, time of access, length of time of access, order of access in relation to other keys. An otherwise valid user session may be restricted from accessing data when certain conditions are not satisfied. These conditions can be arbitrarily defined and assigned to any data item. For example, if a particular data item should only be accessed from users within a certain geographical region and at a certain time of day, the system will not allow the user to access this data file if those conditions are not met. The system array provide certain “canned” restriction types for convenience, but additional restrictions may be added.

The system applies the access restrictions to the data element level. This approach can maximize flexibility where each data item, for example a social security number, could have its own set of access restrictions that could be different from another social security number. In addition, the access restrictions can be arbitrary and may be expressed as Boolean expressions and stored as metadata. All access restrictions are fragmented, encrypted, disassociated, and dispersed to prevent hackers from discovering or altering the restrictions.

FIG. 23 is a flowchart illustrating a method 2300 for restricting data access in accordance with various aspects of the present disclosure. Referring to FIG. 23, at block 2310, a request to access data may be initiated. At block 2315, access restrictions and/or conditions for accessing the data may be determined. Access restrictions/conditions may include, but are not limited to user roles, compound keys, geo location, time of access, length of time of access, order of access in relation to other keys. At block 2320, the access restrictions and/or conditions may be evaluated. At block 2325, it may be determined whether the access restrictions/conditions have been met.

In response to determining that the access restrictions/conditions have not been met (2325-N), at block 2330 access to the data may be denied. In response to determining that the access restrictions/conditions have been met (2325-Y), at block 2335 access to the data may be permitted.

### XII. Hacking

In accordance with various aspects of the present disclosure, rapid detection technology supports “honey pot keys” which when used will trigger specified action for example, but not limited to, alerts, key rotation, etc. Honey Pot keys are exposed keys left for hackers and/or illicit software to find.

Valid access keys and credentials are necessary for user to properly access data protected by the system. The Rapid Detection algorithm triggers an exception event if an incorrect key is used to access any data. The keys may include “honey pot” keys which could be left for hackers to find and attempt to use as well as “duress keys” which are entered by legitimate users under force. Exception events caused by incorrect or false keys can be used to automatically rotate keys, shut out users, and alert security personnel.

FIG. 24 is a flowchart illustrating a method 2400 for detecting and responding to hacking attacks in accordance with various aspects of the present disclosure. Referring to FIG. 24, at block 2410, a data access request may be initiated and received by the system. At block 2420, an access key provided with the data access request may be validated. For example, a rapid detection algorithm may be applied to the access key. At block 2430, it may be determined whether the access key is valid for the requested data. In response to determining that the access key is valid (2430-Y), at block 2440, access to the requested data may be granted.

In response to determining that the access key is not valid (2430-N), at block 2450, access to the requested data may be denied. At block 2460, a response protocol may be initiated. For example, the response protocol relay cause the user that initiated the data access request to be logged out completely, may deny access only to the requested data item, or may allow access to only a limited set of data. Alternatively or additionally, the protocol may notify system administrators of the access attempt with an invalid access key and/or rotate encryption keys and/or shutdown the system.

### XIII. Ransomware

In accordance with various aspects of the present disclosure, anti-ransom encryption protection may include “canary files” used by the system to determine if a system has been unexpectedly altered before data is operated on, for example to create a backup archive. The system makes the assumption that a ransomware attack will happen and accordingly makes regular backups for recovery. However, damaged files infected by a ransomware virus should not be backed up. For an enterprise using the system to archive users' hard drives on a network, “canary files,” which are small files scattered throughout the user's hard drive, are used. If any of these canary files are missing or altered, it is an indication that the drive has been compromised. Before performing a backup, the system will check for the canary files, thereby preventing a backup of an infected drive (and potential overwrite of the last good backup). To recover from an attack, the last good archive can be decrypted to replace the contents of the infected hard drive.

FIG. 25 is a flowchart illustrating a method 2500 for detecting and responding to ransomware attacks in accordance with various aspects of the present disclosure. Referring to FIG. 25, at block 2510, upon a first access of a disk drive by the system, the system may install one or more canary files. For example, small known files may be scattered throughout the disk drive. At block 2520, a status check of the disk drive may be performed by verifying whether the canary files are valid. For example, the installed canary files may be compared with the expected number and content of the canary files. A missing or altered canary file may be an indication that the disk drive has been compromised.

At block 2530, it may be determined whether the disk drive has been infected with ransomware. For example, the system may determine if any of the canary files are missing or altered. In response to determining that the disk drive has not been infected (2530-N), at block 2540, the disk drive contents may be encrypted and backed up to another to another disk drive.

In response to determining that the disk drive has been infected (2530-Y), at block 2550, backup of the disk drive may be postponed. Postponing disk drive backup prevents overriding a last known good copy of the disk drive contents. At block 2560, an alert may be triggered to notify administrators of the infected disk drive. At block 2570, the disk drive contents may be restored from a previously backed up version.

### XIV. Searching Encrypted Data

In accordance with various aspects of the present disclosure, Accelerated Access Records (AAR) for pre-indexing data are stored separately from the data to be indexed and may be mined by 3rd party software to provide analytics and reporting. AARs are optimized search records that can be integrated into third party search tools providing advanced analytics and reporting. These search records may be stored by the system separately on another server for security purposes. This second server, also running the system security software, can have a separate authentication layer allowing 3rd party access and/or 3rd party search tools.

FIG. 26 is a flowchart illustrating, a method 2600 for enabling searching on encrypted data in accordance with various aspects of the present disclosure. Referring to FIG. 26, at block 2610, data is stored on a disk in the system. At block 2620, the data may be checked to determine whether the data should be searchable. In response, to determining that the data should not be searchable (2630-N), at block 2640 the system may encrypt and backup the disk contents.

In response to determining that the data should be searchable (2630-Y), at block 2650 the system may add accelerated access records (AARs) to a remote server drive on the System. At block 2660, when the data is searched, the AARs may be accessed to search for encrypted content.

### XV. Data Encryption

In accordance with various aspects of the present disclosure, all data encrypted by the system may be stored and organized into a user-definable set of locations called a Virtual Cryptological Container (VCC). Encrypted data may be dispersed across multiple data stores in the VCC.” These VCCs may span from a single device, for example, but not limited to a USB stick, up to multiple data centers, and may have dynamically definable locations. Unauthorized relocation of these VCCs to other devices is detectable by the system and could trigger any number of actions including disabling access and key rotation.

The VCC may be configured such that it exists entirely on a single drive or on multiple drives across multiple data centers and formats. The flexibility of this approach stems from the ability of the system to virtualize storage such that applications do not care how or where the encrypted data is being stored. Applications only to interact with the system for sending data to encrypt and for retrieving that data to decrypt. The system may manage one or more storage locations. Some benefits of this approach may include:
A VCC may exist wholly within a single hard drive making it easy to transport safely to another hard drive For example, a VCC can be placed on a USB stick and remain fully encrypted until such time the system is used to access that VCC.
A VCC may have markers that restrict its use under certain circumstances. For example, a VCC can be encoded to work only when located on a specific drive or hardware MAC Address or some other signature ID. the VCC can be restricted to work only when accessed from a specific geo location or a certainly time of day or date. The system will not be able to encrypt or decrypt data unless these VCC conditions are met.
A VCC eliminates an application needing to know that the underlying storage media is and what the specific API is for that media. For example, there are many cloud data stores such as Amazon S3 and MS Azure that all have unique APIs that must be integrated into the application before those services can be utilized. The system may provide a single API to all those storage options including direct on-device storage.
Replication and backup options are facilitated through the use of a VCC and a variety of options may exist. For example, if a VCC is wholly stored on a single device, such as a tablet computer, the VCC may be periodically duplicated and stored off-device as backup. If a VCC spans multiple storage locations, the system may be configured to replicate each storage request in real time to a parallel VCC. The underlying data stores (e.g., Amazon S3 Cloud) may also have their own backup process enabled which will work seamlessly with the system.

FIG. 27 is a flowchart illustrating a method 2700 for utilizing a virtual cryptological container for storing encrypted data in accordance with various aspects of the present disclosure. Referring to FIG. 27, at block 2710, a setup configuration file including a pathname to each of the available storage locations may be specified. The storage locations may be on a hard disk drive on the device, may mounted drives in a LAN or across a WAN to remote cloud service endpoints, or may be a combination thereof. The setup configuration file may also specify other system options.

At block 2720 the system may be launched, and at block 2740 a VCC may be established. For example, the system may read the setup configuration file and establish the VCC for subsequent access. At block 2750, the system may be accessed to encrypt or decrypt data. For example, an application that needs to encrypt or decrypt data may lake an API call to the system. At block 2760, the data may be encrypted or decrypted via a VCC as requested by the application. For example, the system may execute the application's request by encrypting and storing the data in the VCC or retrieving and decrypting data stored in the VCC.

### XVI. Additional Features

In accordance with various aspects of the present disclosure, the system may include a security engine having an ability to adapt to regulatory restrictions. The system may be configured with non-export restricted AES-128 or lower ciphers. Alternatively, the system may be configured to utilize FIPS 140-2 libraries or an external encryption hardware appliance. The system is not tied to any encryption cipher and therefore adapts and grows with user needs and requirements. For example, for users in countries where strong crypto libraries cannot be exported to the system may be configured with libraries permitted under US export law.

Further, the system may operate as a centralized server or encryption appliance as well as having an ability to run on an endpoint device to protect data upon capture. In accordance with the present disclosure, the data fragments may have tamper detection upon being received to eliminate possibility of hacker changing data in transit. The system authenticates individual fragments as they are being received. Several methods may be used to perform this authentication including but not limited to GCM based AES-256 encryption. Fragments that fail this authentication are identified as tampered and will be rejected. Depending on configuration, FHOOSH will respond in a variety of ways such as key rotation, connection termination or by resending the fragment.

While various embodiments have been described above, it should be understood that they have been presented by way of example only, and not of limitation. The breadth and scope should not be limited by any of the above-described exemplary embodiments. Where this document refers to technologies that would be apparent or known to one of ordinary skill in the art, such technologies encompass those apparent or known to the skilled artisan now or at any time in the future. In addition, the described embodiments are not restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features of the described embodiments.

Furthermore, although items, elements or components can be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases can be absent.

What is claimed is:

1. A method for authenticated communications between devices, the method comprising:
establishing communications for data streaming between a first device and a second device;
establishing a shared key;
exchanging the shared key between the first device and the second device;
encrypting a dataset by the first device using the shared key;
decrypting the dataset by the second device using the shared key;
evaluating key regeneration criteria to determine whether the shared key should be regenerated;
in response to determining that the shared key should be regenerated,
generating a new shared key, and
encrypting a next dataset by the first device using the new shared key.

2. The method of claim 1, wherein the establishing a shared key comprises:
providing encryption algorithm parameters and a seed for an encryption algorithm.

3. The method of claim 1, wherein the exchanging the shared key comprises integrating a plurality of key exchange methodologies.

4. The method of claim 3, further comprising:
dynamically varying at least one of the key exchange methodology and frequency of key exchange.

5. The method of claim 4, wherein at least one of the key exchange methodology and frequency of key exchange is dynamically varied based on performance requirements of the first device or the second device and a security threat level.

6. The method of claim 1, wherein key regeneration criteria are evaluated to determine whether the shared key should be regenerated.

7. The method of claim 6, wherein the key regeneration criteria identify possible encryption algorithms and specific parameters for the encryption algorithms.

8. The method of claim 6, further comprising monitoring conditions that indicate when the shared key should be regenerated until key regeneration criteria are met.

9. The method of claim 1, wherein the generating the new shared key comprises:
providing new encryption algorithm parameters for the shared key.

10. The method of claim 1, further comprising:
providing high security by utilizing secure keys and maximizing a rate of key rotation for a dataset.

11. A system for authenticated communications between devices, the system comprising:
a communications interface; and
a processor configured to:
establish communications for data streaming between a first device and a second device;
establish a shared key;
exchange the shared key between the first device and the second device;
encrypt a dataset by the first device using the shared key, wherein the second device decrypts the dataset using the shared key;
evaluate key regeneration criteria to determine whether the shared key should be regenerated;
in response to determining that the shared key should be regenerated,
generate a new shared key, and
encrypt a next dataset by the first device using the new shared key.

12. The system of claim 11, wherein the processor is further configured to establish a shared key by providing encryption algorithm parameters and a seed for an encryption algorithm.

13. The system of claim 11, wherein the processor is further configured to wherein the processor is further configured to integrate a plurality of key exchange methodologies for the shared key exchange.

14. The system of claim 13, wherein the processor is further configured to:
dynamically vary at least one of the key exchange methodology and frequency of key exchange.

15. The system of claim 14, wherein at least one of the key exchange methodology and frequency of key exchange is dynamically varied based on performance requirements of the first device or the second device and a security threat level.

16. The system of claim 11, wherein the processor is further configured to:
evaluate key regeneration criteria to determine whether the shared key should be regenerated.

17. The system of claim 16, wherein the key regeneration criteria identify possible encryption algorithms and specific parameters for the encryption algorithms.

18. The system of claim 16, the processor is further configured to:
monitor conditions that indicate when the shared key should be regenerated until key regeneration criteria are met.

19. The system of claim 11, wherein the processor is further configured to:
provide new encryption algorithm parameters to generate the shared key.

20. The system of claim 11, further comprising:
the processor is further configured to:
provide high security by utilizing secure keys and maximizing a rate of key rotation for a dataset.
